(19) United States
(12) Patent Application Publication
(10) Pub. No.: US 2003/0172002 A1
(43) Pub. Date: Sep. 11, 2003

(54) Menu driven management and operation technique

(76) Inventors: Mario Cosmas Spira, Erlangen (DE); Erich Niedermayr, Vatersteeten (AT); Gunter Menden, Heroldsbach (DE); Hans Klemme-Wolff, Dietikon (CH); Bernhard Sommer, Wien (AT); Perry Michael Cavanagh, Alberta (CA); Kimberly James Pfeifer, Alberta (CA); Krzysztof Goly, Alpharetta, GA (US); Jurgen Stubiger, Erlangen (DE); Jorg Tautrim, Beckingen (DE); David Lesley Williams, British Columbia (CA); Michael Wilcox, Swanne (GA); Giuseppe Zancolich, Alphretta (GA); Michael Taylor, Ontario (CA); Schulze Horn Hannes, Erlangen (DE)

Correspondence Address: SCHIFF HARDIN & WAITE, 6600 SEARS TOWER, 233 S WACKER DR, CHICAGO, IL, 60606-6473, US

(21) Appl. No.: 09/980,643

(22) PCT Filed: Mar. 15, 2001
(86) PCT No.: PCT/US01/08328

(51) Int. Cl. G06F 17/60

(52) U.S. Cl. 705/27

(57) ABSTRACT

A method for doing business includes a menu of services From which services are selected and performing those services on an outsourced basis to plants, such as industrial plants. An overall plan for providing maintenance and technical services for businesses and plants, as broadly defined, includes generic procedures for the services written as a manual of standard practices. A knowledge base or experience database of data and people is utilized, and both hardware and software tools are selected and used in providing the services. Technical services are offered to customers on all outsourced basis according to a menu of services available. A menu is provided for categories of equipment on with the technical services provider offers technical services and a menu is also provided identifying the technical services which are offered. The services are modular and are selected based upon the customer's needs. The modular services are offered at two levels, a basic level and a high end level. Motor services are offered to customers on an outsourced basis according to a menu of services available. The services are modular and are selected based upon the customer's needs. The modular services are offered at two levels, a basic level and a high end level.

### TECHNICAL FIELD

The present invention relates generally to a management and operation technique and in particular to a management and operation technique for plants, such as industrial plants and facilities, including providing maintenance and technical services to plants on an outsourced basis at all stages in the plant life cycle.

### BACKGROUND ART

As global competition increases and supply chains become shorter, businesses are being forced to find new ways to increase plant performance while simultaneously reducing costs. Complexity of the business adds to the costs, and one area of significant complexity for manufacturing businesses is plant maintenance. In addition to adding complexity, maintenance can make up anywhere from 5-40% of the total costs of production. While maintenance is critical to the business outcome, it is often regarded as a necessary evil, and as a result it has been difficult to achieve sustained improvement in performance from an in-house maintenance group without intense management effort that detracts from the core business process.

For complete plants or, for example, production lines, it is known to provide (under classic maintenance contracts) fixed prices for a qualified availability of the production means according to the default of the customer (e.g. 90%, 95%, 98%).

The qualified availability is determined by the customer on the basis of his experience (which availability he must have).

Furthermore, bonus/penalty maintenance service is known; an availability variable is thereby determined (90%, 95%, 98%, 100%). If a better availability or 100% is reached, a bonus is paid; if less is reached, there is a penalty incurred.

According to the prior art, the following maintenance services, for example, are being done for the customer: Personnel, repair service/exchange service, partially including stock keeping, software update or suchlike.

Technical services are performed at manufacturing plants and other types of plants and business facilities by employees of the business or by outside service providers.

According to the current state of the art, the case is such that in the majority of instances the customer pays for the provided services to the plant by the service provider according to time and expense. The individual services are performed on the basis of specific contracts; i.e. software updates are made, motors are replaced, system status analyses are carried out, motor status analyses are carried out, motors are rewound, etc., when the customer considers it necessary or following some corresponding guidelines. Up to now, the providing of services has all been a transactional relationship.

Among the services provided according to the known art are emergency services, usually with appointment of personnel to perform the service, and repair/replacement services. The repair/replacement service partly ensues with warehoused parts of the service provider. When a software update is made, this likewise ensues with standard software that is then brought up to the needed system condition on the basis of the functional errors that then turn up.

Motor management services are performed at manufacturing plants and other types of plants and business facilities by employees of the business or by outside service providers.

Businesses operate out of buildings and other structures and facilities. These can be referred to as plants. Plants for purposes of the present invention are defined broadly to include airports, steel mills, hospitals, mines, ship yards, large buildings, hotels, chemical plants, cement plants, subway systems, railway systems, container terminals, oil drilling rigs or platforms, paper mills, oil or natural gas pipeline systems, lime plants, water treatment plants including desalination, fresh water pipelining and waste water treatment, food service facilities, etc. The management of each plant has typically be performed on a local level by the owner or operator of the plant. For instance, a steel mill has a manager or management group that works at the mill and oversees operations. The manager may rely on outside sources for information but otherwise supervises the operations strictly on a local level. The manager is an employee of the mill. Successful operation and the profitability of the plant depends in part on the skill and resources of the manager at addressing management and operations issues.

Services are known which outsource an aspect of plant operations. For example, an outsource company contracts with the plant to provide all maintenance services on the equipment bought by the plant from that company.

The above-described prior art is not what is best for the customer. The customer needs a technologically and organizationally better solution.

### DISCLOSURE OF THE INVENTION

In one aspect, the present invention provides a menu of services to the owners or operators of a plant for a variety of management and operation services. The owner or operator is able to select from the menu a custom combination of services that fit the plant and the owner or operators needs.

In this way, customized services are provided to the plant to provide a long term and comprehensive strategy for the company. This provides business based methologies for the services.

By providing maintenance services to a broad spectrum of customers in very different markets, considerable knowledge is amassed and familiarity with many different situations acquired, thereby utilizing economies of scale, The knowledge learned from different situations is maintained in a database of systems and people, which is tapped to assist individual customers with different problems.

By handling the services end of the business for the customer, the customer is able to concentrate on the running of the business without concern for keeping abreast of changes in the service aspect.

The present method offers the possibility for risk sharing services, which focuses the cost of the services on the outcome to the business. This is a business partnering approach to providing services that represents a win/win situation for both the receiver and provider of the services.

The present services are set up after visits to the customer's business and discussions with the customer's personnel. This permits an assessment of the financial requirements, the maintenance requirements of the equipment and the special circumstances of the business. Key performance indicators are generated for each customer to permit both the provider and receiver of the services to evaluate the effectiveness of the provided services.

An objective of the present invention is to provide a definition and implementation of methods and tool systems to deliver value-added and integrated plant maintenance.

The present invention provides a collection of operative business and maintenance processes in a comprehensive and merged description, referred to here as a manual. The present invention also provides guidelines for selecting and integrating software and hardware tools and resources to perform the process steps outlined in the manual. This includes identifying and providing best-in-class software. Resources include consultants and cooperation partners. A further aspect of the invention is to provide an experience database, termed a knowledge database that includes data and people which are consulted either occasionally or constantly for guidance. The knowledge base includes data from project experience, regional business information, data relating to technical equipment, cost models and the like. This knowledge base forms a plant maintenance repository of historical data that is consulted for predictions of plant events, system and component failure modes and events. By consulting the knowledge base, the maintenance of the plant is optimized based oil market demands and historical records.

The modules, which are implemented through software modules and hardware, are installed at a local level in each plant. However, operation and control of the service is provided through regional facilities that are linked to the local facilities by a communication connection, such as through the Internet. The regional facilities are provided at regions around the globe so as to offer 24 hour support to the local service locations, including providing a regional center in the Far East, one in the European Union, and one in a NAFTA country. One of these regional centers are open during business hours at any time of the day to provide support for the local service locations. The regional centers are in turn connected via communication links to a single world-wide headquarters.

The process descriptions provided by the manual bring visibility to the support strategies of a business so that priorities may be assigned. Interfaces become transparent and experience in one region can be used in another. A continuous improvement process may be undertaken. By exchanging experience, best practices sharing can be performed so that every unit works according to the same rules.

Additional aspects of the invention provide written strategy and methods, understanding of know-how based on business processes and know-how based on technical processes, and integration and piloting.

Thus, the present invention provides a manual of uniform practices relating to technical services for use by plants and facilities to achieve reduced costs, greater efficiency, and higher profits. The manual is utilized along with a database of experience through communications channels to the plant or facility for added benefits. Software and hardware are utilized in combination, and together with the manual and experience database yields optimum financial results.

The present invention is utilized along with outsourced technical services and maintenance technology provided to plants as a part of a business strategy. According to the present invention, plants are defined broadly to include airports, steel mills, hospitals, mines, ship yards, large buildings, hotels, chemical plants, cement plants, subway systems, railway systems, container terminals, oil drilling rigs or platforms, paper mills, oil or natural gas pipeline systems, lime plants, water treatment plants including desalination, fresh water pipelining and waste water treatment, food service facilities, etc.

These services are provided at all phases in a plants life cycle, including planning of the plant, erecting the plant, operation the plant and managing the shut down of the plant.

The outsourced services are founded on a knowledge base comprising experienced personnel and business plans shown to have been effective, as well as of gathered historical data.

The present invention provides the manual as a presentation layer for presenting information on the maintenance architecture to the customer or potential customer as well as to guide and assist personnel of the services provider.

Thus, the present invention proposes a better solution for the customer, particularly to improve its financial plant result (its profit). For this purpose, the availability is adapted to the requirements of the production process, of the market, etc. (an ice factory does not need a high availability in the winter, for example; the same is valid for a gift shipping company after Christmas). As a result of PMTA, an optimal solution is possible for the customer given minimal costs of the individual service process, so that a particularly low service price can be offered to the customer despite a permanent availability of the service. This is his advantage.

According to a further aspect, an object of the invention is to provide a better solution for providing technical services to a customer, particularly to enhance the customer's financial system result (profit) and to lower the costs over the life time of the system (life time costs). For this purpose, the availability and the reliability—in the form of availability time windows on demand—are adapted to the demand of the production processes, of the market, etc. The present invention makes an optimum solution of the customer needs possible, i.e. a solution matched to the customer business demands.

A further object is to provide increased equipment reliability and availability, reduced costs through a proactive Business Based Maintenance approach, minimized downtime, optimized asset management, capital solutions, and fast response when and where it is needed.

Another object of the present invention is to provide modular standardized services for technical support. A customer is offered modular services and free to select those technical services that meet the customer's needs.

A further object of the invention is to provides technical services at two levels, a basic level and a high end options level. Examples of high end options include business oriented services, financing, full coverage for repair and replacement, etc.

Another object of the invention is to offer to the customer a menu of equipment which can be covered by the technical services and to also offer to the customer a menu of technical services.

In the present system, a customer desiring maintenance services or other technical services is provided a menu of available technical services from which to select desired technical services. A uniform service architecture is provided. Modules are provided at various business levels, from the general to the specific. In one embodiment, three levels are provided. Examples of the three levels include a business-oriented level that is offered as an option, a technology-oriented level that is offered as modules, and a device level which is referred to as a equipment spectrum.

The maintenance services offered also fall into the broad areas of technical services, consulting, repair service, parts supply, etc. The customer needs are evaluated using an audit and interview process and the customer is offered the services as modules selected from a menu. The modules, which are implemented through software modules and hardware as well as maintenance processes and procedures, are installed at a local level in each plant. However, operation and control of the service is provided through regional facilities that are linked to the local facilities by a communication connection, such as through the Internet. The regional facilities are provided at regions around the globe so as to offer 24 hour support to the local service locations, including providing a regional center in the Far East, one in the European Union, and one in a NAFTA country One of these regional centers are open during business hours at any time of the day to provide support for the local service locations. The regional centers are in turn connected via communication links to a single world-wide headquarters.

Electronic system plans are employed, potentially based on standard organization software like CMMS (Computerized Maintenance Management Systems), CAD data, electronic handbooks, and Excel lists. This software is respectively employed at a location of a specific customer or can be provided over the internet. An Enterprise Asset Management System (EAMS) is utilized between the individual locations, and the Enterprise Resource Planning System is located over the whole thing, this running, for example, on the basis of SAP program technology. The individual programs run on a standard operating system platform; they are implemented either in the computer system of the customer system or on servers of the respective provider center, for instance a Customer Service Center. However, monitoring by the respective Customer Service Center is always a feature, this center being in charge in a country or international regions as well, for example USA and Canada. Communication via the Internet with special measures for secure transmission are provided.

The present invention provides outsourced technical support as a part of a business strategy. The outsourced technical support is provided for plants or parts of plants. According to the present invention, plants are defined broadly to include airports, steel mills, hospitals, mines, ship yards, large buildings, hotels, chemical plants, cement plants, subway systems, railway systems, container terminals, oil drilling rigs or platforms, paper mills, oil or natural gas pipeline systems, lime plants, water treatment plants including desalination, fresh water pipelining and waste water treatment, food service facilities, etc.

The maintenance services offered also fall into the broad areas of technical services, consulting, repair service, parts supply, etc. The customer needs are evaluated and the customer is offered the services as modules selected from a menu.

Decisions on maintenance services are divided between the global, regional or local level. Business strategies for the customer, choices of modules to use, etc. are preferably made on the global level. Regional level decisions are determined by regional laws and regulations, manpower availability, etc. The local level is the plant level wherein decisions at that level are specific to the needs of that plant.

Within the context of the present application, maintenance services refers to and includes all those services described herein.

The invention addresses the challenges being put to companies by reducing complexity, thereby enabling greater focus on the core business. One area of significant complexity for manufacturing businesses is plant maintenance.

The present invention delivers business-based professional maintenance services on a modular basis throughout the world, not only for systems and installations, but for all machinery and equipment. The present invention utilizes vast worldwide technical expertise and presence to provide the business-based maintenance, for example, by focusing on business aspects such as return on assets, return on investments, and plant and equipment availability for producing output.

Businesses face increases in productivity demands and international competition while striving to keep up with technical developments. The present invention provides outsourcing of numerous internal processes as a cost effective and asset effective strategy. The outsourced services cover maintenance during the operational phase and include the modernization of a plant.

As a further service, on-call and logistic services provide dependable requirement-oriented fault elimination of product systems and plants. Field service staff is available at the plant and repair services carry out necessary repair work at repair centers while on-line service centers communicate directly with the technical plants. Logistics services ensures that the correct parts are provided.

Thus the present invention provides commercially focused strategies and takes on more performance based relationships with customers that include accepting more calculated risk in a win-win partnership approach. The invention provides for a full range from small contracts with few services to comprehensive (all inclusive) maintenance agreements at the other end of the spectrum.

A more specific aspect of the present invention is embodied in a motor management program. An object of this aspect of the invention is to provide a better solution for providing motor services to a customer, particularly to enhance the customer's financial system result (the profit of the customer) and to lower the costs over the life time of the system (life time costs). For this purpose, the availability and the reliability of the motor system—in the form of availability time windows on demand—are adapted to the demand of the production processes, of the market, etc. The present invention makes an optimum solution of the customer motor service needs possible, i.e. a solution matched to the customer business demands.

A further object is to provide increased motor reliability and availability, reduced costs through a proactive Business Based Maintenance approach, minimized motor downtime, optimized asset management, capital solutions, and fast response when and where it is needed.

Another object of the present invention is to provide modular standardized services for motor management. A customer is offered modular services and free to select those motor services that meet the customer's needs.

A further object of the invention is to provides motor services at two levels, a basic level and a high end options level. Examples of high end options include business oriented motor services, financing, full coverage for motor repair and replacement, etc.

In the present system, a customer desiring maintenance services is provided a menu of available motor services from which to select desired motor services modules. A uniform service architecture is provided. Modules are provided at various business levels, from the general to the specific. In one embodiment, two levels are provided. Examples of the two levels include a business-oriented level that is offered as an option and a technology-oriented level that is offered as basic modules.

The present motor management program has been developed based on the view of motors and motor servicing by many businesses. Motors are viewed by many businesses as a commodity item, and the present motor management program provides and services the motors and provides various aspect of motor maintenance for this “commodity”. A further reason for addressing motors specifically in the present invention is that many businesses see motors as a hand-through, or pass-through, portion of their business that historically may have some aspects provided by outside suppliers. It is easier to convince the business operator to change to the present modular outsourced services for motors than for some aspect of maintenance that has traditionally been performed by the business only in-house. A further advantage is that the business may neither have the expertise nor interest in optimizing the motor aspects of their plants. The present invention provides such expertise as a service and addresses it from a business-oriented approach with a view to the bottom line of the plant.

The motor maintenance services offered also fall into the broad areas of technical services relating to motors, such as: consulting, repair service, motor supply, etc. The customer needs are evaluated using a business review and interview process and the customer is offered the services which are found to meet the customer's needs as revealed in the business review as modules selected from a menu. The modules, which are implemented through software modules and hardware as well as motor maintenance processes and procedures, are installed at a local level in each plant. However, operation and control of the service is provided through regional facilities that are linked to the local facilities by a communication connection, such as through the Internet or via a dedicated phone line or private network. The regional facilities are provided at regions around the globe so as to offer 24-hour support to the local service locations, including providing a regional center in the Far East, one in the European Union, and one in a NAFTA country. One of these regional centers are open during business hours at any time of the day to provide support for the local service locations. The regional centers are in turn connected via communication links to a single world-wide headquarters.

Electronic system plans are employed, potentially based on standard organization software like CMMS (Computerized Maintenance Management Systems), CAD data, electronic handbooks, and Excel lists. This software is respectively employed at a location of a specific customer or can be provided over the Internet. The individual programs run on a standard operating system platform; they are implemented either in the computer system of the customer system or on servers of the respective provider center, for instance a Customer Service Center. However, monitoring by the respective Customer Service Center is always a feature, this center being in charge in a country or international regions as well, for example USA and Canada. Communication via the Internet with special measures for secure transmission is provided.

The present invention provides outsourced motor maintenance as a part of a business strategy. The outsourced motor is provided for all motors in a plants or a defined scope of motors in a plant. According to the present invention, plants are defined broadly to include airports, steel mills, hospitals, mines, ship yards, large buildings, hotels, chemical plants, cement plants, subway systems, railway systems, container terminals, oil drilling rigs or platforms, paper mills, oil or natural gas pipeline systems, lime plants, water treatment plants including desalination, fresh water pipelining and waste water treatment, food service facilities, etc.

The motor maintenance services offered also fall into the broad areas of technical services, consulting, repair service, parts supply, etc. The customer needs are evaluated and the customer is offered the services as modules selected from a menu.

Decisions on motor maintenance services are divided between the global, regional or local level. Business strategies for the customer, choices of modules to use, etc. are preferably made on the global level. Regional level decisions are determined by regional laws and regulations, manpower availability, etc. The local level is the plant level wherein decisions at that level are specific to the needs of that plant.

Within the context of the recent application, motor maintenance services refers to and includes all those services described herein.

The invention addresses the challenges being put to companies by reducing complexity, thereby enabling greater focus on the core business. One area of significant complexity for manufacturing businesses is plant maintenance.

The present invention delivers business-based professional motor maintenance services on a modular basis throughout the world. The present invention utilizes vast worldwide technical expertise and presence to provide the business-based maintenance, for example, by focusing on business aspects such as return on assets, return on investments, and motor availability for producing output.

Businesses face increases in productivity demands and international competition while striving to keep up with technical developments. The present invention provides outsourcing of motor maintenance processes as a cost effective and asset effective strategy. The outsourced motor services cover maintenance during the operational phase and include the modernizations.

As a further service, on-call and logistic services provide dependable requirement-oriented fault elimination for motors. Field service staff is available at the plant and repair services carry out necessary repair work at repair centers while online service centers communicate directly with the technical plants. Logistics services ensures that the correct motor parts are provided.

Thus, the present invention provides commercially focused strategies and takes on more performance based relationships with customers that include accepting more calculated risk in a win-win partnership approach.

The present invention is part of a broader concept of providing a broad range of technical services to plants, this being described in more detail in a PCT patent application for Technical Services Program, docket number P00,1821, filed by the applicant of the present application, the content thereof being incorporated herein by reference. An overall concept of providing outsourced services is disclosed in a PCT patent application entitle Plant Maintenance Technology Architecture docket number P00,1823, filed by the applicant of the present application, the content thereof being incorporated herein by reference. A generally related patent application is a Menu Driven Management and Operation Technique, docket number P00,1824, filed by the applicant of the present application the content thereof being incorporated herein by reference.

### BRIEF DESCRIPTION OF THE DRAWINGS

FIG. 1 is a schematic illustration of the main elements of the present invention, including a process manual incorporating the practices and process of the present invention, knowledge base and tools set;

FIG. 2 is a functional block diagram of communications between plants and regional centers;

FIG. 3 is a diagram of the world indicating plant and regional center locations;

FIG. 4 is a functional block diagram of the main elements of the invention being utilized in a maintenance project;

FIG. 5 is a block diagram of the information flow in the maintenance project at a plant;

FIGS. 6 through 11 show multiple parts of a flow chart illustrating process steps set forth in a process description manual of the present invention;

FIG. 12 is a functional element diagram of an architecture of the knowledge database;

FIG. 13 is a functional element diagram of the software tool sets utilized in the present invention;

FIG. 14 is a time and organization level diagram comparing the present invention to prior arrangements;

FIG. 15 is a process flow of steps to implementation of outsourced maintenance according to the present invention;

FIG. 16 is a schematic diagram showing the equipment spectrum to which the present invention may be applied including showing equipment modules available on an outsourced basis;

FIG. 17 is a schematic diagram showing modules of technical services available under the present invention;

FIG. 18 is a block diagram showing implementation of the technical services;

FIG. 19 is a diagram showing the utilization of the present technical services during the life cycle of a plant;

FIG. 20 is a diagram showing alignment of the customer's goals and the service provider's goals according to the present invention.

FIG. 21 is a schematic diagram of a design model for the present invention;

FIG. 22 is a schematic diagram showing the menu of motor services available under the present invention;

FIG. 23 is a block diagram illustrating an automatic maintenance solution; and

FIGS. 24 and 25 are block diagrams of electronic business transaction according to the present invention.

### MODES FOR CARRYING OUT THE INVENTION

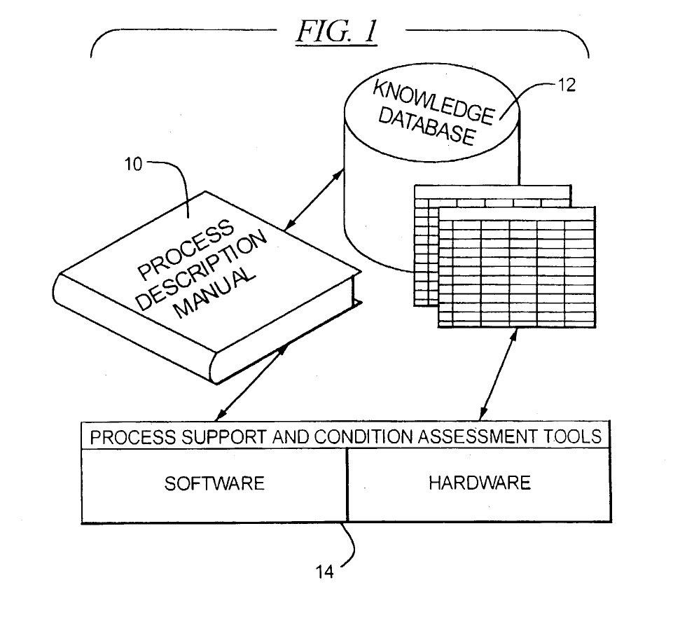

According to FIG. 1, the present invention provides an architecture, including as primary elements a process description manual 10, a knowledge database 12 and hardware and software tools 14, for providing maintenance services to plants and facilities. The process description manual 10, the knowledge base 12 and the tool set 14 are all interlinked to one another as indicated by the arrows. This relationship will be discussed in further detail hereinafter.

The present architecture provides a view to maintenance services as an aspect of the business effecting the bottom line of the plant, which is outlined in the manual 10. The present architecture considers maintenance services from a global view, from a regional view and from a local view.

Experience on a global and regional scale is gathered in the knowledge database 12 and used to increase bottom line profits at the local plant. The database 12 includes not only data but also experts on various maintenance issues, and these experts are made available on a regional basis for the local plants.

The tool set 14 includes both process support tools and condition assessment tools for the maintenance services, and these may include both software and hardware tools. These are chosen utilizing shared information from the global and regional information found in the manual 10 and the database 12, so that a best of class tool set is made available at the local level.

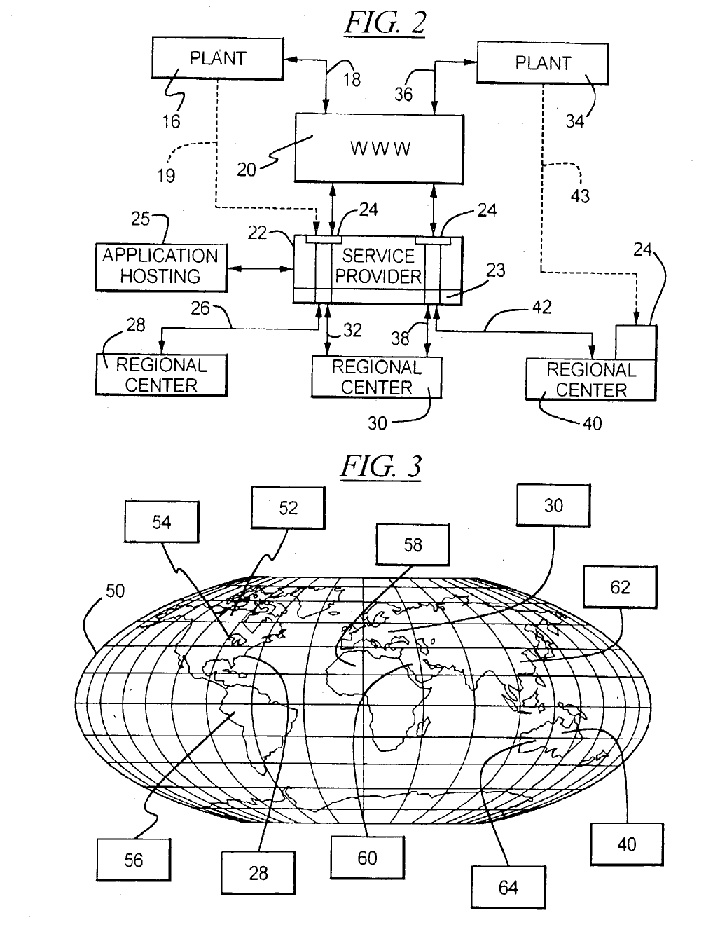

FIG. 2 shows the communications channels between plants at which maintenance services are being provided and regional centers of expertise, which serve as repositories for the knowledge base, as provided according to the present invention. A plant 16 is a customer located in a first country of the world. The plant 16 is a plant according to the broadly defined term that includes airports, steel miles, hospitals, mines, ship yards, large buildings, hotels, chemical plants, cement plants, subway systems, railway systems, container terminals, oil drilling rigs or platforms, paper mills, oil or natural gas pipeline systems, lime plants, water treatment plants including desalination, fresh water pipelining and waste water treatment, food service facilities, etc.

A communication channel 18, either by wire or wireless, connects the plant 16 to a network 20, such as the Internet, and specifically the World Wide Web of the Internet. The plant 16 has access through the World Wide Web 20 to a maintenance service provider 22 which provides outsourced maintenance services to the plant 16. Preferably, a firewall 24 is provided at the communication channel to ensure security of data behind the firewall. The communication channel is carried through the service provider by a channel 26 to a center of expertise 28 located in a first region. The first region is the region of the world in which the country of the plant 16 is located. The plant 16 is able to obtain expert advice and guidance in maintenance issues by consulting with the experts and others at the center 28. The experts and others at the center 28 have at hand the data of the knowledge database 12 which is consulted as a guide.

The connection channels between the elements of FIG. 2 are preferably secure connections, such as by utilizing encryption and/or other security measures. As an alternative, the communication channel between the plant 16 and the service provider 22 may be by a dedicated phone line or internal network connection, as indicated at 19. This dedicated connection 19 is through the firewall 24 for security reasons.

The plant 16 has the tools 14, both hardware and software, for carrying out the maintenance services at the plant. In some instances, the software tools may not be installed in the plant 16, but can be accessed over the network connections. The service provider 22 performs the function of application hosting, as shown at 25. The service provider 22 has at hand the process manual 10 on which the maintenance architecture is based, and the plant 16 and regional center 28 may also have the process manual 10.

The center 28 may not always be available, however, since it may be after working hours at the regional center 28. In this case, the inquiry from the plant 16 is forwarded to a second regional center 30 through a communication channel 32. The second center of expertise 30 is located in a different region of the world than the first center 28, and so is still open during its working hours. The customer 16 need not know that the second center 30 is being accessed, however, since the communication channel 32 is selected by the service provider 22 based on regional center availability.

A second plant 34 in a different country also has maintenance services provided by the service provider 22. The plant 34 consults with a regional center of expertise 30 in the second region of the world so long at the center 30 is open (on duty) and available. The communication channel includes a wired or wireless link 36 through the World Wide Web 20 and through the firewall 24 of the service provider 22 to the center 30 by a communication channel 38. If the center 30 is on duty, the inquiry is answered or the assistance is provided. However, the center 30 may no longer be on duty, so that the service provider 22 forwards the support inquiry to a third regional center 40 through a communication channel 42. As a further alternative, the plant 34 may have a direct connection 43 to the regional center 40 and so bypass the service provider 22. It is preferred in this instance to provide the regional center 40 with a firewall 24 for security.

The function of redirecting the inquiry is transparent to the plant making the request and is handled by a directory layer 23 within the service provider 22. Every center of expertise need not have the same information or expert personnel available, and so the directory layer 23 is also used to redirect inquiries to the center having the needed expertise. Multiple centers of expertise may be provided within each region, if desired. Plants in may different countries have a center for expertise available to them whenever help is needed.

In FIG. 3 is shown the world 50 indicating the locations of the regional centers 28, 30 and 40, for example. The locations of plants around the world are shown, including plants 52, 54 and 56 in a region belonging to the regional center 28, plants 58 and 60 in the region of the center 30, and plants 62 and 64 in the region of the center 40. Thus, each region of the world is covered by a regional center, and if a local center for a particular plant is off duty, another center in another region of the world is on duty and takes the inquiry. Continuous service is therefore provided 24 hours per day, in all time zones of the world, but without requiring 24 hour staffing at any one center.

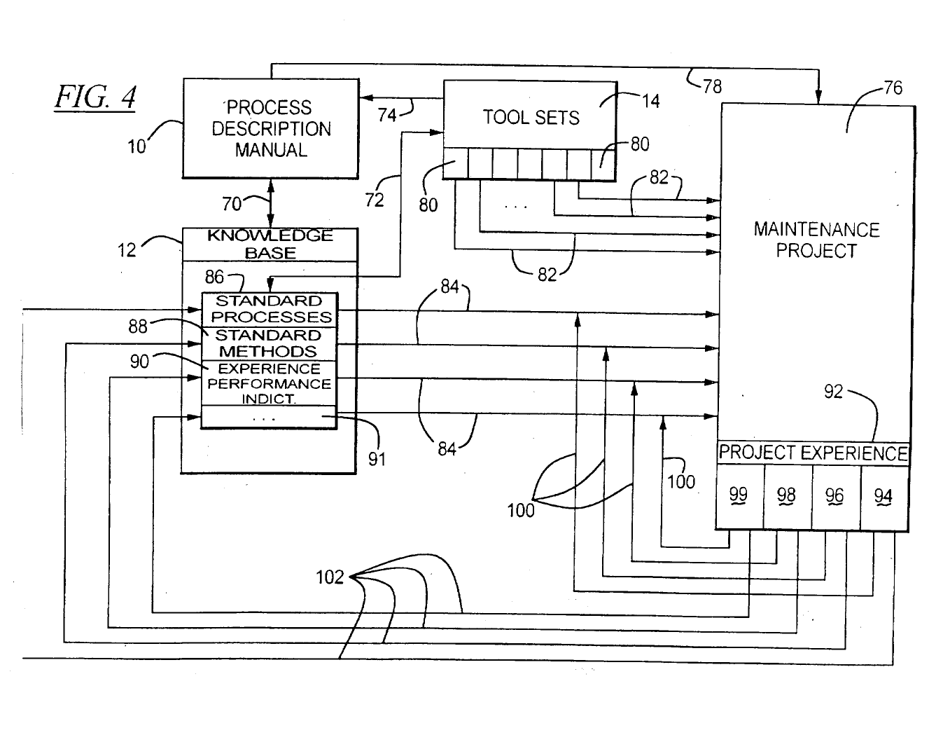

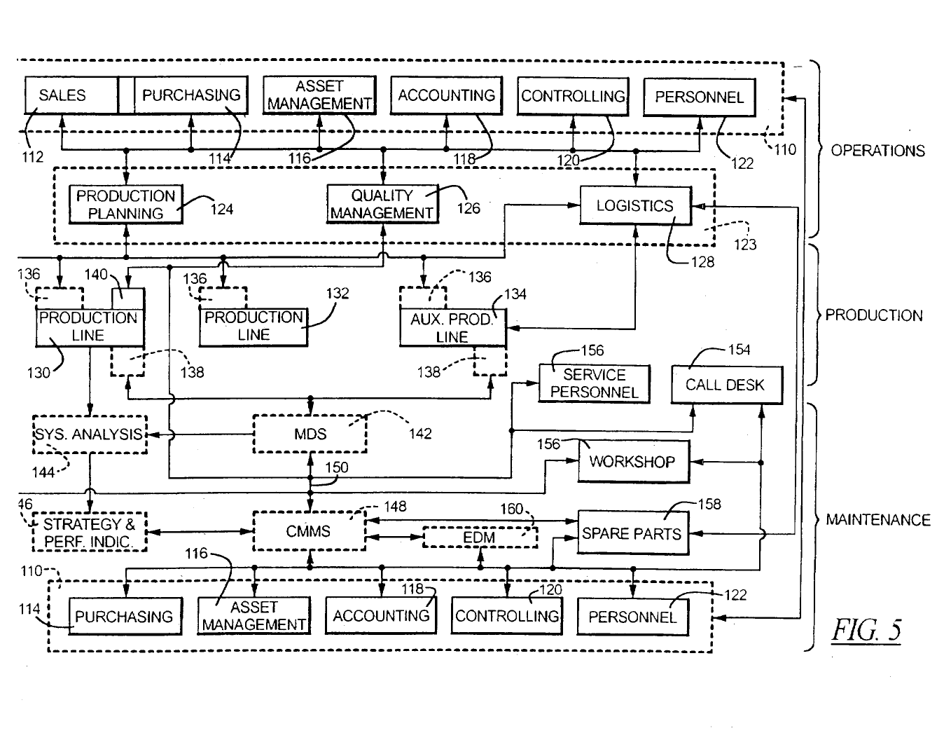

According to FIG. 4, an execution of the maintenance is shown including the process manual that includes reference links 70 to the knowledge database 12. The knowledge base has data and process links 72 to the tools 14, and the tools 14 provide reference links 74 back to the process manual 10. The manual 10 leads to the application of the concepts to a maintenance project 76 at a plant as shown at 78. The tools 14 include individual tool elements 80 that are applied to the maintenance project 76 as indicated at 82. The maintenance project 76 is in a specific region and has specific content and is in a specific industry. Performing the maintenance project 76 requires providing initial information, which comes from the knowledge base 12 as indicated at 84. These various leads indicate the input of standard processes 86, standard methods 88, experience performance indicators 90, and further information 91. The processes 86 are generally high level and include a sequence of actions to goal, while the methods are a low level and are components of the processes, generally being analytical. The further information 91 includes information illustrated and discussed in conjunction with FIG. 11.

After the maintenance project 76 is running, project experience is gained, as shown at 92, The experience leads to improvements in the processes 94, methods 96, performance indicators 98 and the further information 99 (see FIG. 11). These improvements are fed back as shown at 100 to the maintenance project 76. The improvements resulting from the experience 92 are also fed back to the knowledge base 12 and applied to the corresponding parts thereof, as indicated at 102. The knowledge base 12 is thus updated as new information becomes available based on experience. The knowledge base 12 is shared by all the regional centers and so is applied world wide, or may be regionalized.

The information model (data flow model) is shown in FIG. 5 for the present invention within a plant, such as plant 16. In particular, the plant is divided into operations, production and maintenance portions. The illustrated plant may include the entire plant, or may be just a portion of the plant to which the present maintenance services are provided. In the plant operations portion is found a block for enterprise resource planning 110, that includes the functions of sales 112, purchasing 14, asset management 116, accounting 118, controlling 120 and personnel 122. The enterprise resource planning 10 is shown in dotted outline to indicate that this functional element of the plant is, or may he, in communication with the knowledge base 12, such as through a regional center 28 and is thus supported by the present maintenance services architecture.

In communication with all of the enterprise resource planning elements is a management portion 123 including production planning 124, quality management 126 and logistics 128. These elements of management are supported as well by the present invention and are on communication with the knowledge base 12 as shown by the dotted outline.

In the production portion of the plant, which represents the plants key competency, is found first and second production lines 130 and 132 and an auxiliary production line 134. The production lines each have a digital control system 136, which may be in communication with the knowledge base 12 according to the present invention, A condition monitoring system 138 is also provided for each production line, which is connected to the experts at the-regional centers as shown by the dotted outline. A quality management component 140 is provided as well.

The maintenance portion of the plant is the heart of the services that may be provided on an outsourced basis under the present invention. The maintenance portion has a maintenance decision support component 142 in communication with the condition monitoring systems 138 of the productions lines. The maintenance decision support component 142 monitored by the knowledge base 12 as shown by the dotted outline. Information from the maintenance decision support component 142 is provided to a systems analysis component 144, also linked to the knowledge base under the present method, which in turn communicates with a strategy and performance indicator component 146. Information from the maintenance decision support component 142 is transmitted back and forth with a computerized maintenance management system 148 via a bus 150 that also communicates directly with the strategy and performance indicator component 146. The computerized maintenance management system 148 which may be in communication with the knowledge base 12 according to the present invention. The bus 150 provides communications with service personnel 152 and a maintenance call desk 154 as well as to a workshop 156 and to the production planning 124 and quality management 126.

The logistics component 128 communicates to a spare parts management component 158, that also is in communication with the computerized maintenance management system 148. Also in communication with the computerized maintenance management system 148 is an engineering data management component 160, that has a connection to the knowledge base 12. At the lower portion of the FIG. 5, the maintenance components have their own enterprise resource planning components 110 or share these functions with the operations portion of the plant, depending on company organization. The maintenance components are in communication with the components of the enterprise resource planning 110 components of purchasing 114, asset management 116, accounting 118, controlling 120 and personnel 122. In this instance, personnel include the people, the software and the logic of the plant.

The foregoing is intended as an example of a business organization and is not intended to be limiting to the business structure to which the present invention may be applied.

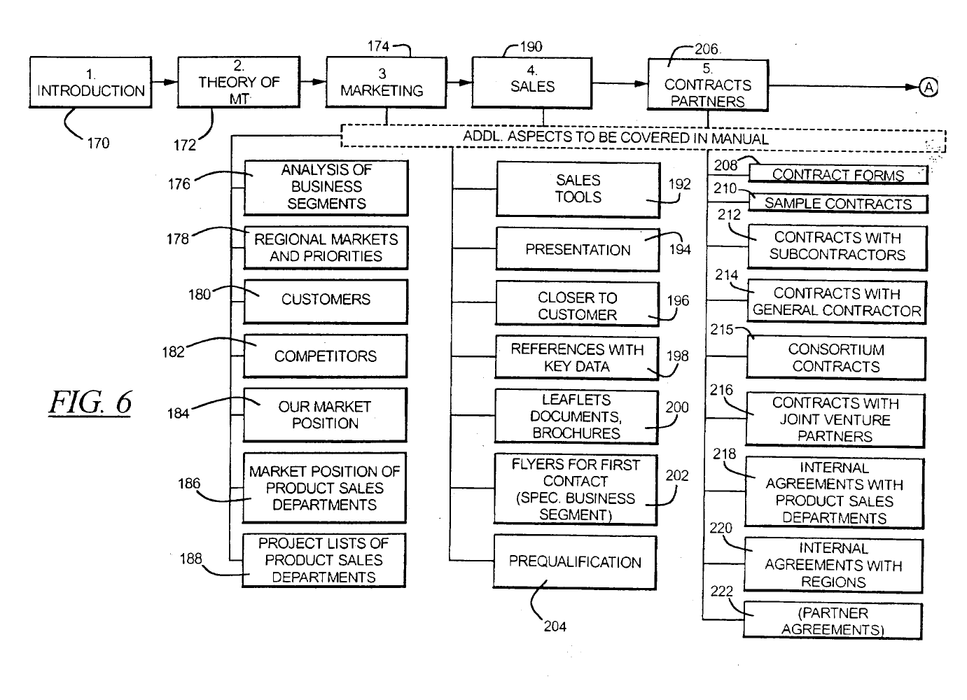

Aspects of the process description manual 10 are shown in a flow chart of FIGS. 6, 7, 8, 9, 10, and 11. The flow chart represents information and guidelines in one embodiment of the manual and is not intended to limit the scope of the invention. In FIG. 6, a first portion 170 of the process manual is an introduction, followed by a section on the theory of management technology 172 and then a portion on marketing 174. Under the marketing portion 174 of the manual are parts relating to analysis of business segments 176, regional markets and priorities 178, customers 180, competitors 182, the plant's market position 184, the market position of the product sales departments 186 and a project list of product sales departments 188.

The next section of the process manual 10 relates to sales 190, including sales tools 192, presentation guidelines 194, proximity to customer 196, preference to key data 198, leaflets and brochures 200, fliers to first contacts 202, and pre-qualification 204. Under section 5 is found contract partners 206 for the maintenance services, which has the subsections of contract forms 208, sample contracts 210, contracts with subcontractors 212, contracts with general contractors 214, consortium contracts 215, contracts with joint venture partners 216, internal agreements with product sales departments 218, internal agreements with regions 220 and partner agreements 222.

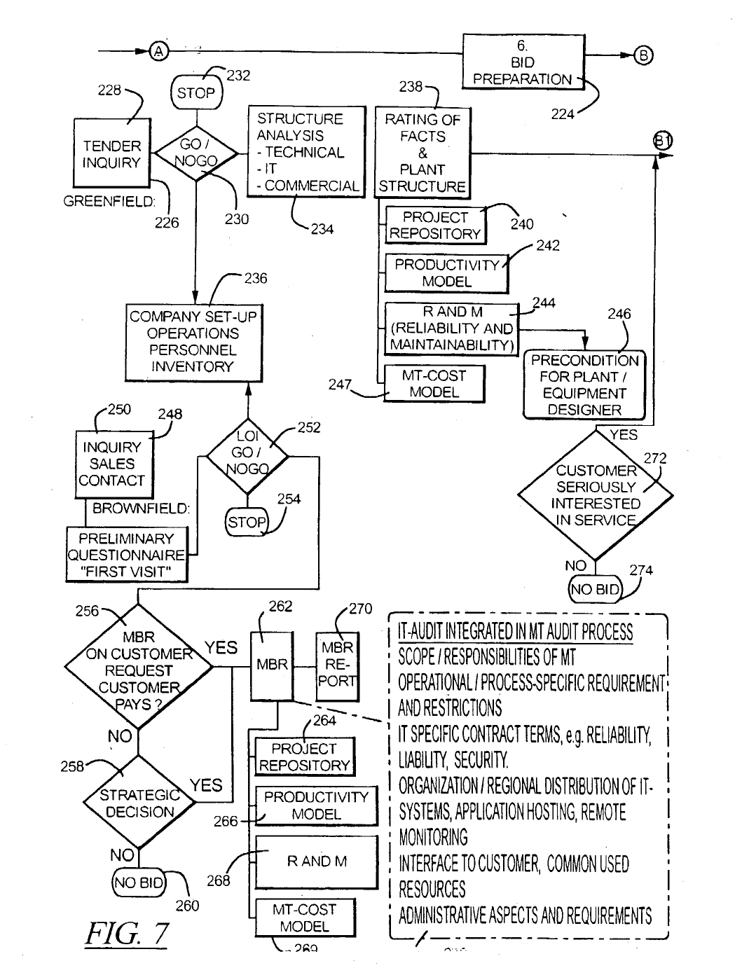

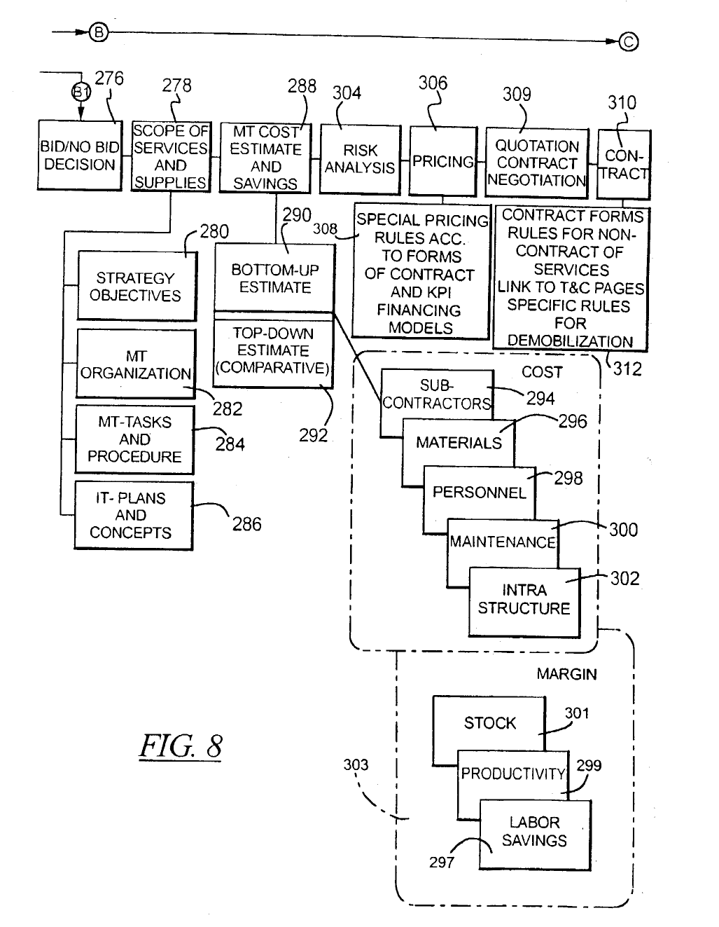

Turning to the continuation on FIG. 7, the manual 10 has a bid preparation section 224 for the plant. The entry point depends upon whether the plant is a greenfield plant (being built on a previously non-industrial site) or brownfield plant being built on a previously industrial site). The greenfield entry 226 provides for tender of an inquiry 228, and making a go/no go decision at 230. No go results in stop 232, while go results in performing a structural analysis of technical, information technology and commercial aspects at 234 as well as setting up of operations, personnel and inventory at 236. The structural analysis 234 leads to rating of the facts and plant structure 238, which includes a project repository 240 and a productivity model element 242 and reliability and maintainability 244 ( which is optional), that lead to a preconditioning for the plant and equipment design 246. Also included is a maintenance cost model 247.

The brownfield entry 248 leads to a sales inquiry contract 250 (may be followed by a preliminary questionnaire in a first visit) and a go/no go decision 252, that is embodied in a letter of intent. No go results in stop 254, while go results in setting up of operations, personnel and inventory at 236 and performing an audit (a business review) on customer request 256, leading to a strategic decision 258 that may result in no bid 260. The bid process continues with a maintenance technology audit 262, that includes a project repository 264, an reliability and maintainability element 266 (which is optional), a productivity model 268 and a maintenance cost model 269. Within the scope of the audit 262 is an audit or business review process, as indicated at 276, including identifying the scope and responsibilities of the maintenance, operational process-specific requirements and restrictions, information technology specific contract terms, such as relating to reliability, liability, security and the like. Additionally, organizational and regional distribution if information technology systems, application hosting and remote monitoring. A further aspect of the audit is interfacing to the customer and identifying commonly used resources. Lastly, administrative aspects and requirements are considered.

Following the maintenance technology audit 262, an audit report, or business review report, 270 is prepared with conclusions and a proposal. Following that, a customer decision 272 is made as whether the customer is seriously interested enough to bid or not to bid. The no bid decision 274 ends the process.

Additional features of the bid process are shown in FIG. 8. For example, a bid/no bid report 276 is made. This is followed by a determination of scope of the services and supply 278, that itself includes strategy and objectives 280, maintenance organization 282, maintenance tasks and procedures 284, and preparation of an information technology plan and concept 286. The process continues with a maintenance cost estimate 288. The cost estimate 288 may he either top down 290 or bottom up 292. Either way, the cost estimate is made based on costs after consulting with subcontractors 294, considering material costs 296, personnel costs 298, information technology costs 300 and infrastructure costs 302. A marginal cost consideration 303, that includes consideration of stock 301, productivity 299 and labor savings 297.

After a cost estimate is prepared, a risk analysis 304 is performed. This leads to pricing 306 of the project. The pricing is determined by specific pricing rules 308 according to the contract and key performance indicators. A quotation is offered and contract negotiations 309 commence. Finally, the contract 310 is prepared, using provided contract forms 312.

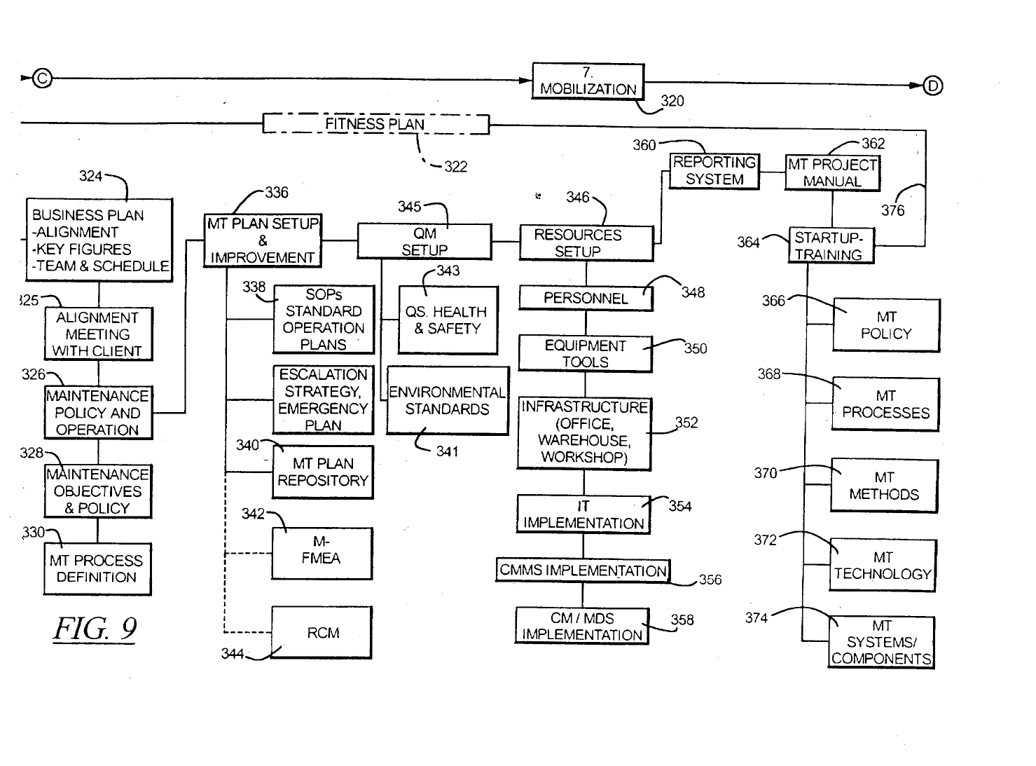

Following the bid process 224 is a mobilization process 320 as shown in FIG. 9. The mobilization includes a six step fitness plan 322 for the plant. The first step of the fitness plan is a business plan 324, that includes elements of alignment, identification of key figures and preparation of a team and a schedule. The business plan is followed with alignment meetings 325 with the customer. The second step of the fitness plan provides a maintenance policy and operation plan 326, which includes the elements of identifying maintenance objectives and policy 328 and a maintenance process definition 330. In the next step, the maintenance plan is set up and improvements are made 336, including implementing standard operation plans 338, escalation strategy and emergency plans 339, establishing a maintenance plan repository 340, a machine failure mode and effects analysis 342 and reliability centered maintenance 344. A quality maintenance setup step 345 is next, with quality, health and safety issues being addressed 343 and environmental standards review 341. After that, resources are set up 346, including assembling personnel 348, equipment and tools 350, infrastructure 352 such as an office, a warehouse and workshop, implementing information technology 354, implementing CMMS and implementing CM and MDS. A reporting system 360 is established as a further step, and lastly, a maintenance project manual 362 is prepared. The project manual 362 is used during the start up and training operations 364 of the plant, including training on maintenance policy 366, maintenance processes 368, maintenance methods 370, maintenance technology 372, and maintenance systems and components 374. This completes the fitness plan as outlined in the manual, as indicated by the embracing line 376.

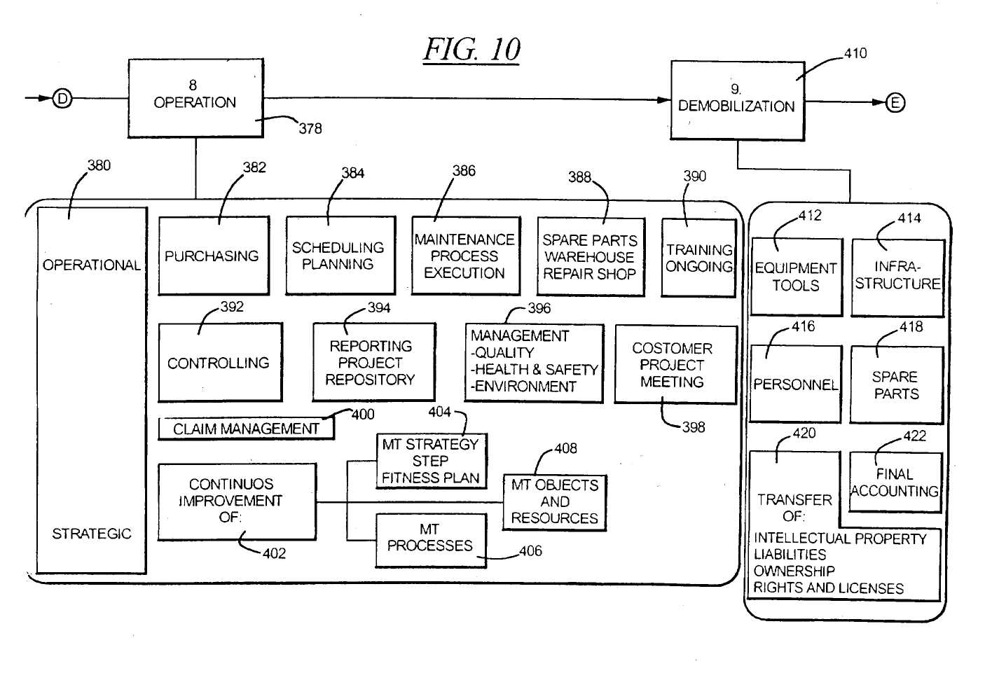

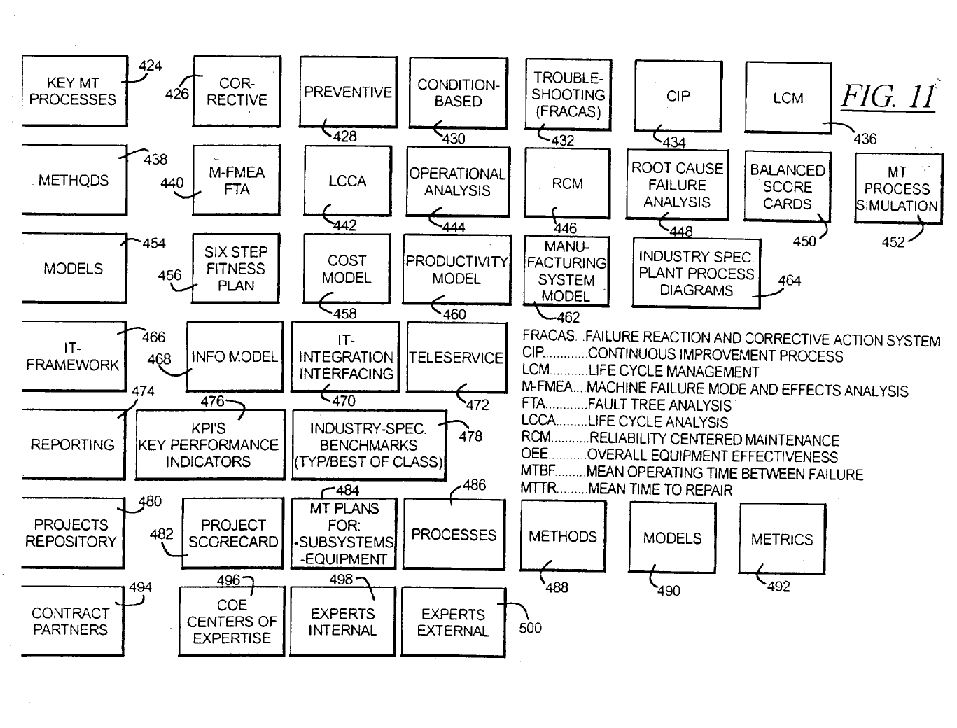

Operation of the plant is covered in section 8 of the process manual 10, as shown at 378 in FIG. 10. Areas addressed in the operations part of the process manual 10 are either more operational or more strategic, as indicated at 380, include purchasing 382, scheduling and planning 384, maintenance process execution 386, spare parts warehousing and operation of a repair shop 388, ongoing training 390, controlling 392, keeping up a reporting project repository 394, and management of quality, health and safety and environmental issues 396. A customer project meeting 398 may be conducted. These aspects all fall under the operational aspects. A further aspect of the operations is a strategic aspect, including a claim agent 400, providing continuous improvement 402 of the following processes: a maintenance strategy with a multi-step fitness plan 404, the maintenance processes 406 and the maintenance objectives and resources 408.

Once the plant is to be shut down, the manual 10 covers demobilization 410 in section 9. This includes considering equipment and tools 412, infrastructure 414, personnel 416 and spare parts 418, as shown in FIG. 10. Another aspect of the demobilization is transfer 420 of intellectual property, of liabilities, of ownership rights and licenses. Lastly, a final accounting 422 is made.

FIG. 11 shows further aspects of various issues addressed in the process manual 10. The left most column relates to classes of information while the corresponding rows extending to the right is the information in that class. First is key maintenance processes 424, such as corrective maintenance 426, preventative maintenance 428, condition-base maintenance 430, trouble shooting 432 utilizing a failure reaction and corrective action system, a continuous improvement process 434 and life cycle management 436. The methods 438 utilized according to the manual include: machine failure mode and effects analysis and failure tree analysis 440, life cycle analysis 442, operational analysis 444, reliability centered maintenance 446, root cause failure analysis 448, balanced score cards 450 and maintenance process simulation 452. Various models 454 are used, including a multi-step fitness plan 456, a cost model 458, a productivity model 460, a manufacturing system model 462, and industry specific plant process diagrams 464. Within the information technology framework 466 is applied information models 468, information technology integration and interfacing 470, and teleservices 472 (which include personal heads-up displays as guides to local maintenance personnel).

Reporting 474 aspects include reporting of key performance indicators 476, and industry specific benchmarks 478. In the projects repository 480 is provided a project scorecard 482, maintenance plans for subsystem equipment 484, processes 486, methods 488, models 490 and metrics 492. A portion directed to contracting partners 494 is provided as well, which is broken down to centers of excellence 496, internal experts 498 and external experts 500.

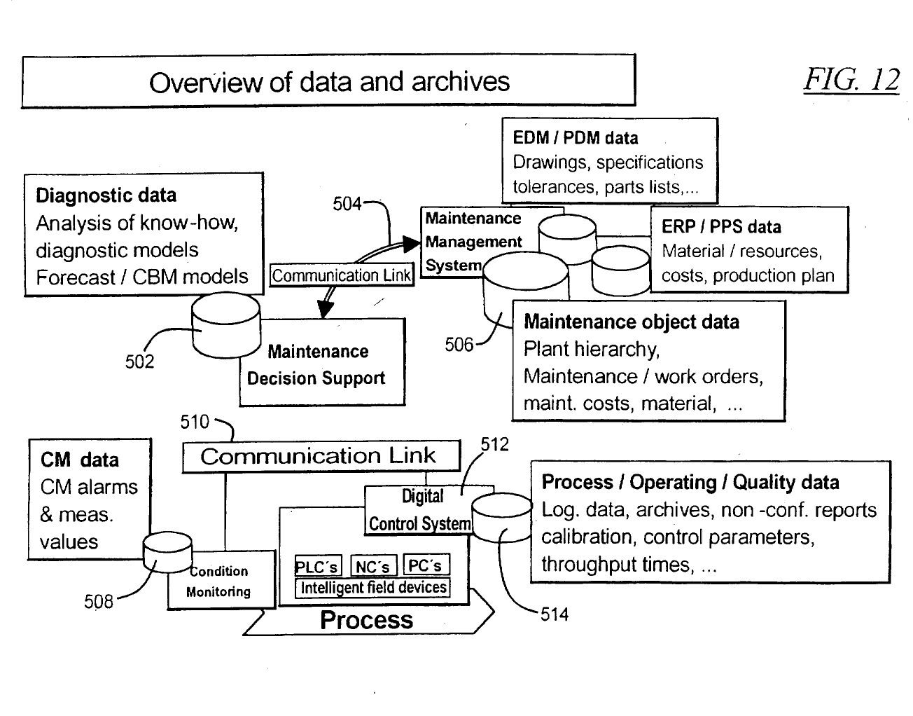

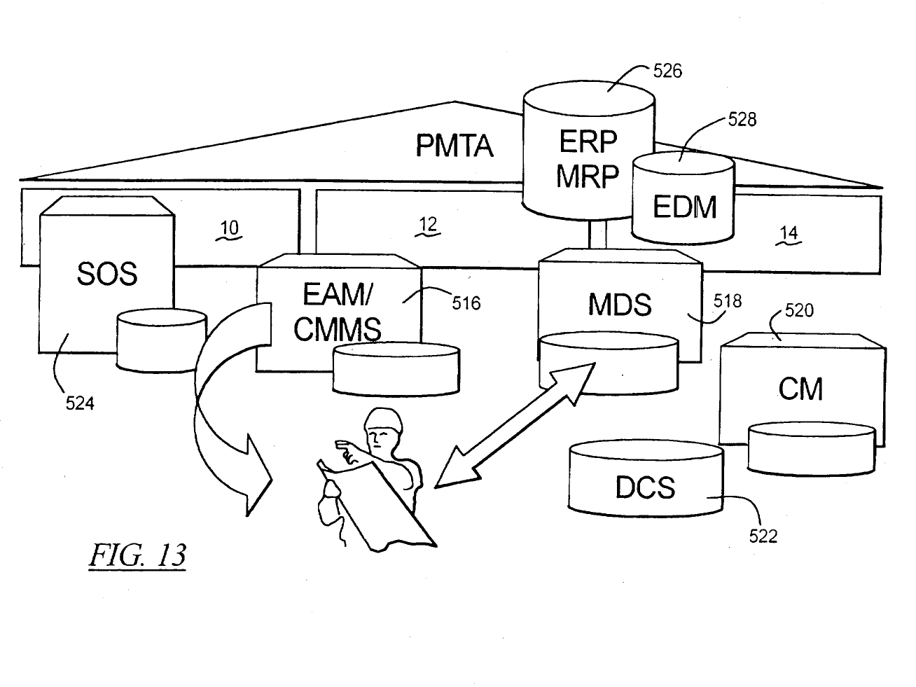

Referring now to FIG. 12, an overview of data and archives in the knowledge database 12 is shown including a store 502 of diagnostic data for analysis of know-how, diagnostic models; forecasting and cost benefit models. This provides maintenance decision support. A communications link 504 to a maintenance management systems store 506 with EDM/PCM data for drawings, specifications, tolerances, parts lists, etc., ERP/PPS data with materials and resources costs, and a production plan and maintenance object data with plant hierarchy, maintenance and work orders, maintenance costs, materials, and the like. Condition monitoring data storage 508 is linked through another communication link 510 to digital control systems 512 which perform processes on data at 514 such as process, operating and quality data, log data, archives, non-conforming reports, calibration, control parameters and throughput times. These processes are performed using various computers, including network computers and personal computers.

FIG. 13 shows the software tools utilized according to the present invention. Plant maintenance technology architecture includes as components computerized maintenance management systems (CMMS) 516, maintenance decision support (MDS) 518, conditioned monitoring systems (CM) 520, digital control systems (DCS) 522, and score card optimization systems (SOS) 524. In additional, it utilizes enterprise resource planning (ERP), and manufacturing resource planning (MRP) 526 and engineering data management (EDM) 528.

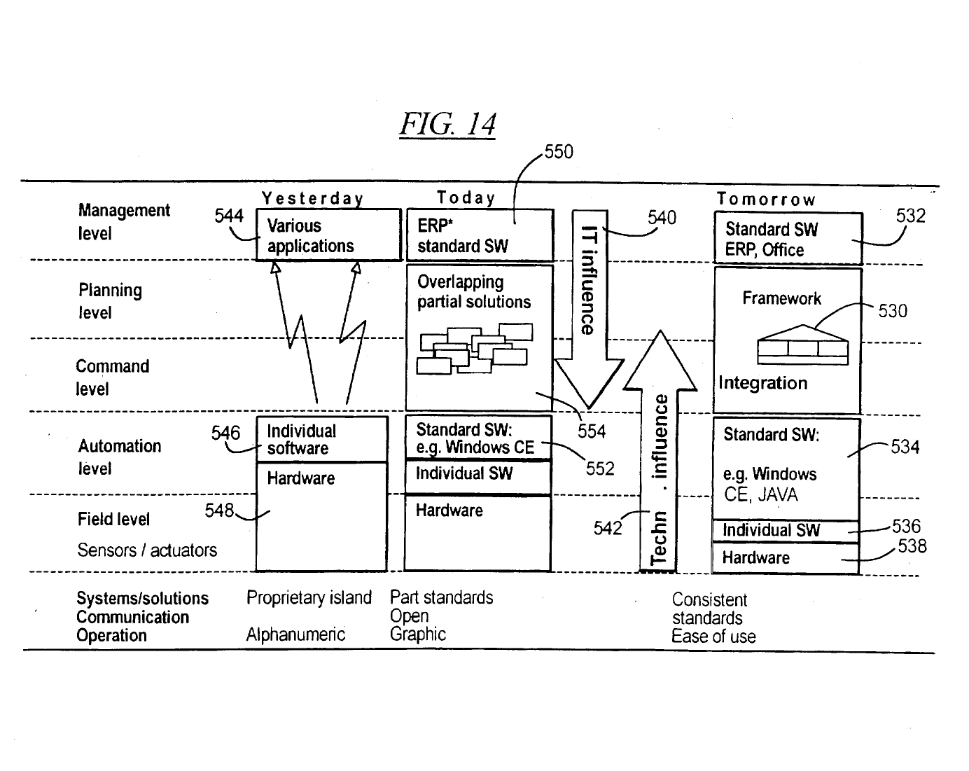

Referring to FIG. 14, information technology integration and software standards are decisive as competitive factors in industry. The present invention provides an integration framework 530 linking standard software and enterprise resource planning 532 at the management level and to software 534 at the automation level through a planning level and a command level. Reliance on individual software 536 and on hardware 538 is reduced. Information technology influence 540 is driven top down from the management level while technology influence 542 is driven upward from the field level. Consistent standards and ease of use are realized. This is a substantial improvement over the past wherein various applications 544 were used at the management level and communicating with individual software 546 at the automation level that in turn was based on hardware 548. An intermediary step has begun to be used which attempts to link standard management software 550 to standard automation software 552 via overlapping partial solutions 554. Neither of these lead to the consistent standards and ease of use of the present invention.

Thus, plant maintenance technology architecture meets its objectives of creation of standardized procedures and reference processes and the development of assessment models as a decision basis for business based maintenance. It defines, dissemination of the know-how is available. The creation of an internal communication and training concept is also applied.

The knowledge based business processes offer scalable solutions for asset management in accordance with the relevant requirements. Establishment of a score card-based optimization system for maintenance strategy is done. Implementation and transfer of the strategy results to the operative management system using computerized maintenance management systems is accomplished. Know-how generation modules for a strategic performance differentiation are provided in addition to a leading competitive edge through certified maintenance management. The knowledge based technical processes offer total productive maintenance and optimization of the plants based on continuous improvement processes. On-line performance monitoring of the plants is offered. The development of a maintenance decision support methods and modules for diagnosis, optimization and residual life estimation are offered. An integration of existing databases containing descriptions of the product, system or plant behavior are available for technical modeling. For example, these relate to wear models. For a commercial condition monitoring, preparation of an evaluation model and competence structure is provided.

Integration of all of the foregoing is accomplished through development of a plant maintenance technology information model, taking standards and strategic system platforms into account. Evaluation of and active support of important standardization activities are accomplished in the maintenance system. Innovative technologies for teleservice and virtual team support are provided. Effective mechanism for experience exchange and knowledge management are installed. And lastly, piloting of methods and solutions modules with selective customers is performed. Each of these is accomplished by repeated reference to a manual of procedures.

The plant maintenance technology architecture is built on a pyramid, the base of which is provided by the methods and tools which are overlaid with the processes and topped off by the process manual. The customer who purchases maintenance services realizes improved bottom line results after implementing the present invention. In particular, plant availability is matched to the market demands while maintenance costs per goods produced are reduced. Strategic knowledge advantages are realized through outsourcing of the maintenance services.

For the provider of the maintenance services, more effective customer care and acquisition is provided, along with more efficient performance of maintenance services through access to comprehensive business and maintenance process descriptions, and through integrating tool-sets and learning experiences into a database.

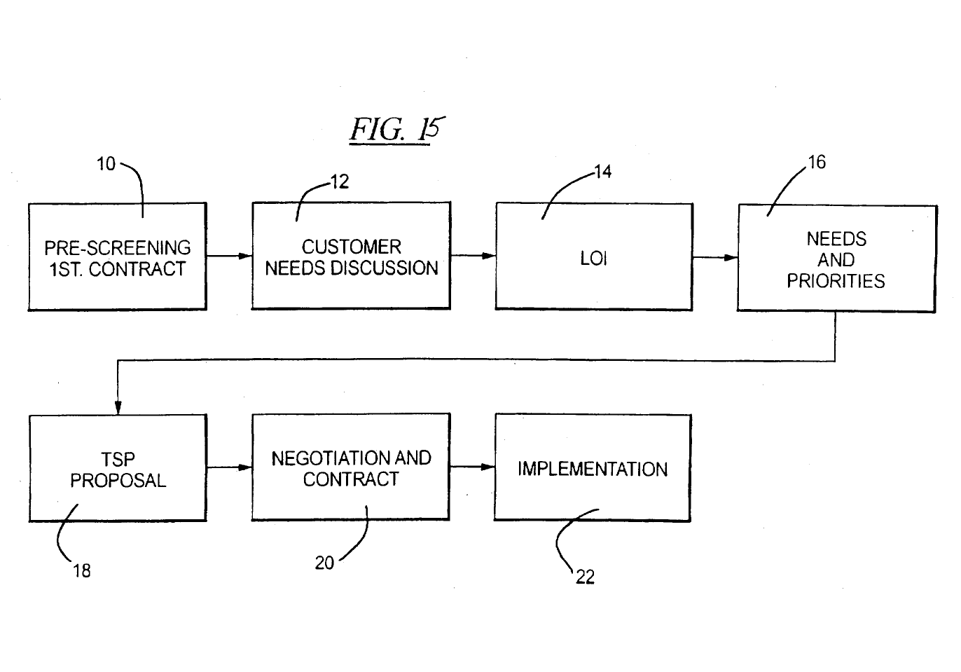

Referring first to FIG. 15, a process for offering technical services to a customer is shown, including first a pre-screening 10 at the first contact with the customer. Included in this pre-screening is a first contact questionnaire to the prospective customer and discovery of information about the prospective customer via the Internet, and other sources.

In a second step, customer needs are discussed 12, which covers finding out what the customer needs, answering a questionnaire directed to the technical services program, which is done through several meetings. A letter of intent 14 is prepared to establish a consensus to consider the technical services program. These first three steps in the process provide tests of the customer's commitment to proceed. The next step is to determine the needs and priorities 16 of the customer. Priority areas for improvement are identified. As a tool to identify these, a maintenance business review having, in one embodiment, 22 aspect areas, might be performed using a questionnaire. Topic areas are set forth for example in tabular format and the questioner observes and asks questions to determine the answers to the questions. The questions are also divided into five levels to identify a sophistication level of the prospective customer's technical and maintenance services, systems and procedures, personnel and resources, and current management and leadership.

For smaller businesses, a brief maintenance business review is offered, directed to 10 to 15 business aspects. This shortens the process from the full review where costs and time commitments are to be kept low.

As a further step 18, a technical services program proposal is prepared and presented to the prospective customer. This is done with reference to the menu of modular services and options which will be discussed later. This menu is also referred to as a program structure. As an important part of the proposal 18, the goals of the business are considered, an implementation plan is developed, a contract structure is determined, a return on investment is studied, and key performance indicators are identified.

These same aspects are considered during the negotiation and execution of the contract 20. Once the contract is made, the outsourced technical services are implemented at 22. A business based maintenance or BBM analysis is performed. An asset condition assessment is performed. Equipment conditions are assessed, and a CIP is implemented. The implementation 22 of the technical services program also utilizes a menu of services.

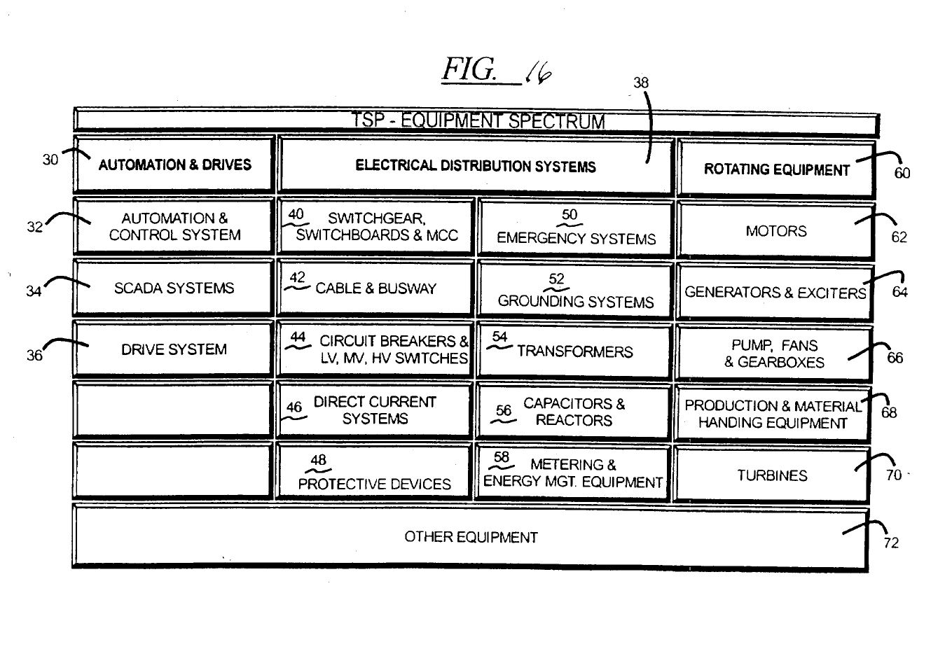

The outsourced technical services offered according to the present invention are provided as a menu of services. One such menu is shown in FIG. 16. The menu of FIG. 16 is an equipment oriented menu offering modules relating to specific equipment. The first section of the menu is directed to a class of equipment grouped as automation and drives 30. Below this are automatic control systems 32, SCADA systems 34 and drive systems 36. The second portion of the menu is directed to electrical distribution systems 38. Under this broad category are modules, or menu items, directed to switchgear, switchboards and MCC's 40. Cables and busway equipment 42 are another module offered, as is circuit breakers, low voltage, medium voltage and high voltage switches 44. The modules under electrical distribution systems further include direct current systems 46, protective devices 48, emergency systems 50, grounding systems 52, transformers 54, capacitors and reactors 56, and metering and energy management equipment 58.

Rotating equipment 60 also must be considered in the equipment modules.

First among rotating equipment is a module directed to motors 62. Thereunder are modules for generators and exciters 64, pumps, fans and gearboxes 66, production material and handling equipment 68, and turbines 70. A general class referred to as other equipment 72 is also provided as a catch all class.

Virtually all of a customer's technical equipment will fall Linder one of the foregoing categories. The customer has certain core complacencies relating to its core business that these should be left to the customer to address. However, the various technical aspects that play a supporting roll in the plant's production may each be addressed by the present invention by selection of corresponding modules from the equipment menu of FIG. 16.

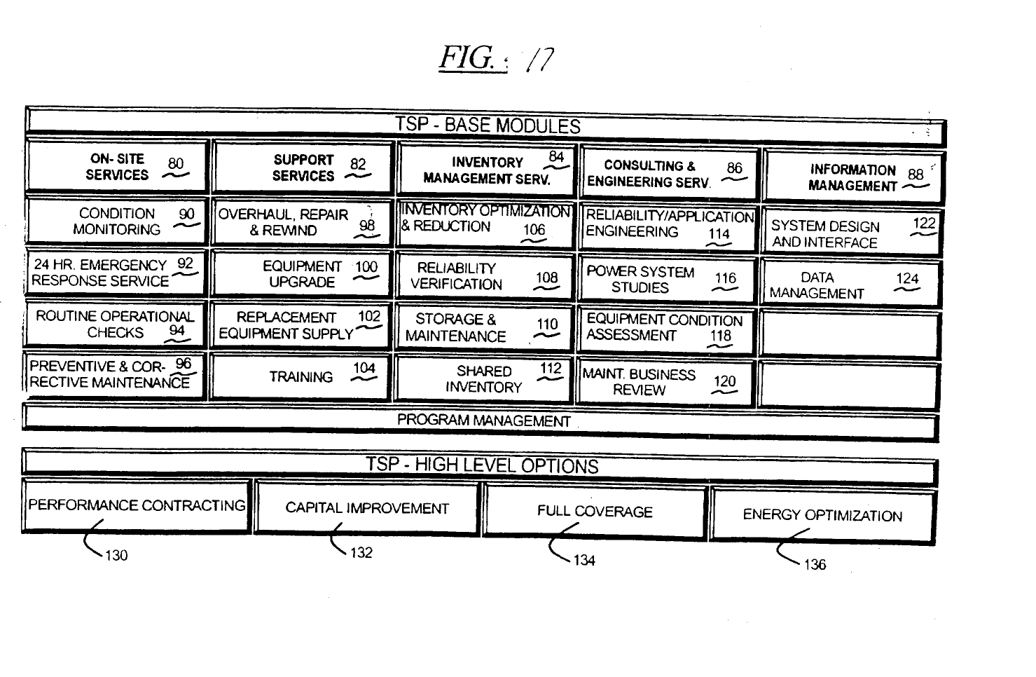

The technical services are also provided as modules offered via a menu as shown in FIG. 17. The upper portion of the menu sets forth the basic modules of the technical services. These are divided into five aspects, including on-site services 80, support services 82, inventory management services 84, consulting and engineering services 86, and information management 88. On site service modules include condition monitoring 90, 24 hour emergency response service 92, routine operational checks 94, and preventative and corrective maintenance 96. Under support services 82 are provided overhaul and repair and rewind services 98, equipment upgrades 100, replacement equipment supply 102, and training 104. The inventory management services 84 provide modules for inventory optimization and reduction 106, reliability verification 108, storage and maintenance 110, and a shared inventory 112. The consulting and engineering services 86 provide reliability and application engineering 114, power system studies 116, equipment condition assessment 118, and a maintenance business review 120. The class of modules relating to information management 88 provide a system design and interface module and a data management module.

Not only are there basic service modules but the present invention also provide high-end modules as shown at the lower portion of FIG. 3. The first such high end module is a performance contracting module 130. This is followed by a capital improvement module 132, a full coverage module 134 and an energy optimization module 136.

The outsourced technical service provider and/or the customer looks to these menus to discover modules that best fit the customer's needs. For example, the customer may choose a storage and maintenance module 110 for transformers 54 and choose a 24 hour emergency response module 92 for switchgear 40, along with other modules.

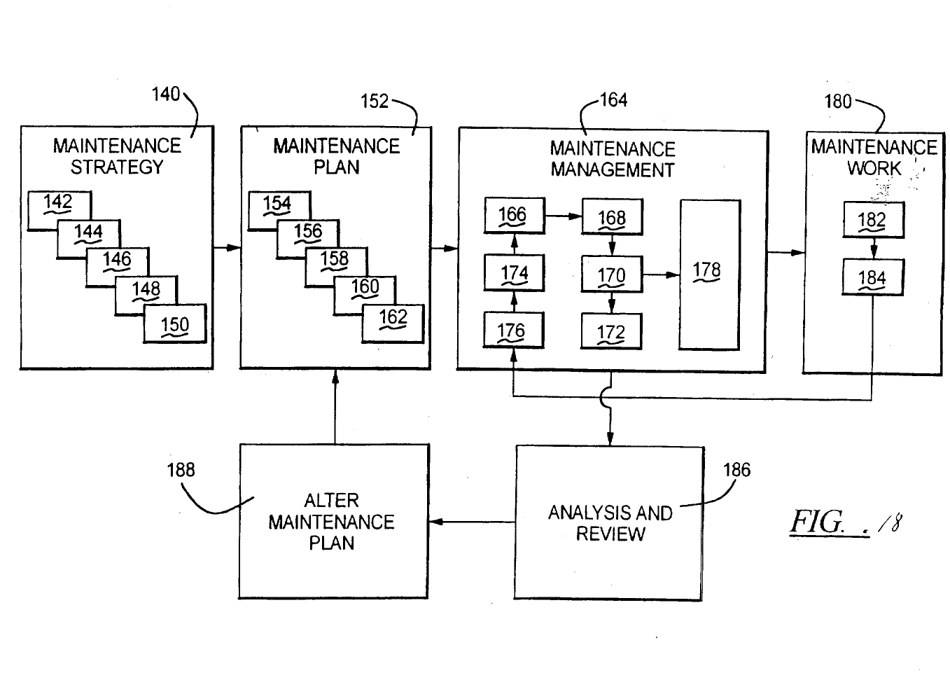

Once the modules are chosen they are implemented, for example, as shown in FIG. 18. The implementation begins with the development of a maintenance strategy 140. The maintenance strategy development requires a business plan evaluation 142, an operational analysis of the plant 144, a critically analysis 146, a component identification 148 and a failure analysis 150. The maintenance strategy 140 is followed by defining maintenance plans 152. According to the invention, the maintenance plan 152 development includes defining a hierarchical plant index 154, determination of key performance indicators 156 for the plant, the assignment of criticalities 158 for the plant components, performance of a failure analysis 160, and assignment of maintenance actions 162.

The plan 152 is the foundation for the maintenance management 164 wherein standard jobs 166 are used for tasks due 168 on work orders 170 and requested work 172. The work orders 170 lead to a work schedule 178. From the management 164, the maintenance work 180 is performed by work groups 182 until the work is completed 184. The completed work feeds back into a work history 176. The work history 176 is provided for an equipment register 174, which is a hierarchical plant structure of the company within which the standard jobs 166 are performed.

The maintenance management part 164 is subject to analysis and review 186 according to this invention. Historical data is reviewed, failure analysis is reviewed. A review is made of safety issues, employ statistical techniques to evaluation frequency of work and employ reliability engineering techniques to evaluate design out requirements. These can lead to an altering of the maintenance plan 188. For example, modification of the quality maintenance plan is done by failure analysis, review of maintenance actions, frequency of work, duration of work and by entering new equipment items. Alterations of the maintenance plan is part of the continuous improvement cycle.

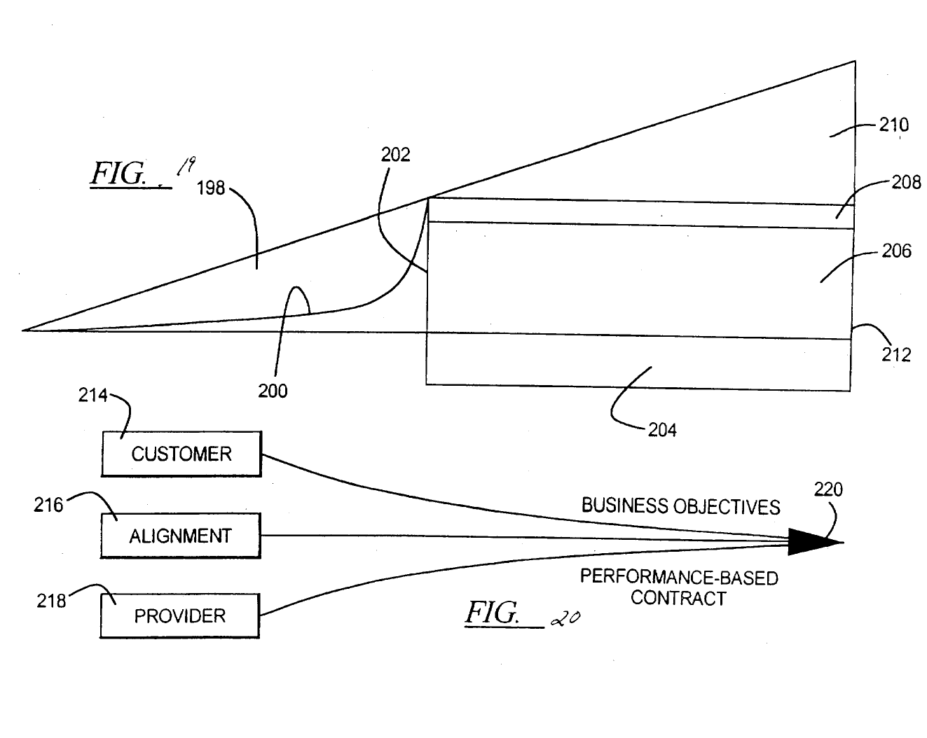

Technical services according to the present invention is involved in a plant during much of the plant's history. For example, as shown in FIG. 19, a plant is constructed at 198 and early on the technical services has only a small involvement as indicated at 200. Just prior to commissioning of the plant at 202, the sharp upswing in the technical services curve indicates increased involvement. After commissioning 202, the operation 204 of the plant provides a foundation on which is built the condition based inspection and preventative maintenance services 206 of the invention. Overlying the inspection and preventative maintenance services 206 is repairs 208 made to the plant during its lifetime. These may fluctuate particularly under the processes of the prior art, but under the continuous servicing provided by the present invention, the repair involvement is steady. Over this is the modernization potential 210 realized by modernization projects. This leads to technical innovation as indicated by the increasing height of the line. The time line of involvement of the technical services program ends at the decommissioning 212 of the plant.

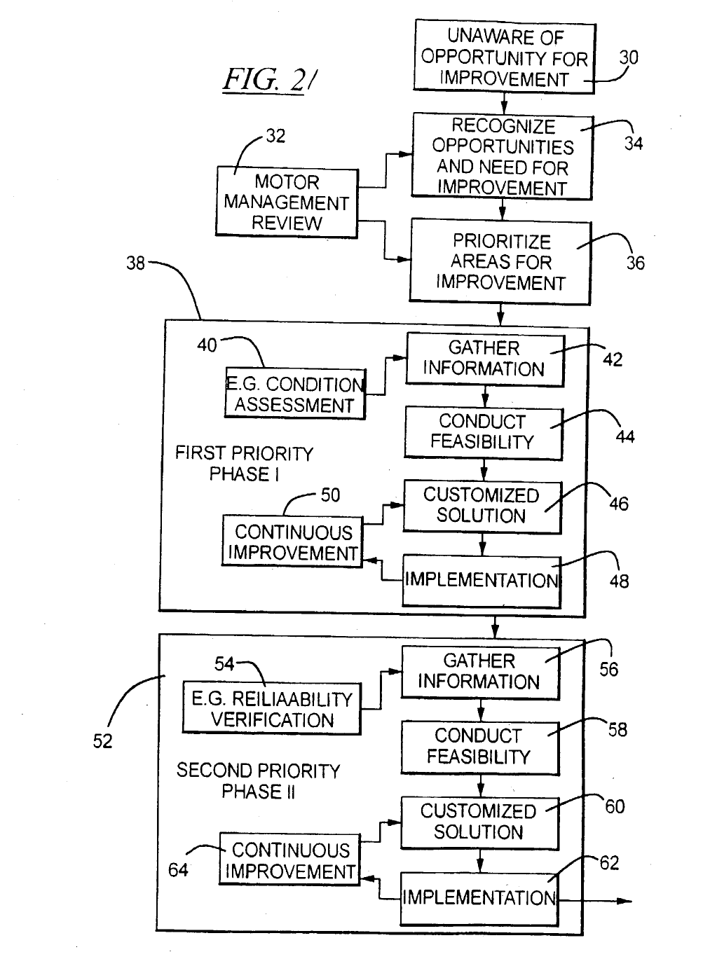

As illustrated in FIG. 20, through the application of the present invention, the business objectives of a customer 214 come into alignment 216 with the business objectives of the service provider 216 under the performance based contract 220.

Thus, the technical support program is a modular service package that tailors the maintenance improvements to the budget of the business and to the customer's business objectives. An important aspect is that the modular service package leaves the core competencies to the business while taking on any or all of the non-core competencies. Benefits are provided including a reduced cost through pro-active business based maintenance, a minimized downtime, an optimized asset management including capital solutions and a fast response when and where the customer needs it.

In further detail, the modules offered under the basic services include a condition monitoring program. Using state of the art methods to assess the condition of the plant and the machinery such as thermography, vibration measurements, ultrasonic testing, partial discharge testing, oil and fluid analysis, and technical endoscopy, advanced warning of problems is provided.

An aspect of the present technical services is that emergency calls costs are covered by the agreement at no added expense to the customer.

In undertaking the technical support program, the maintenance business review has been performed. This identifies improvement potentials so that measures can be derived from that review to improve the maintenance effectiveness, based on the implementation of a continuous improvement process. The goals are to provide short-term recommendations focused on the development and implementation of a Maintenance Quality Improvement Plan and provide short-term recommendations focused on the development and implementation of a Maintenance Quality Improvement Plan.

An audit or review is performed using a standardized approach and objective assessment techniques. Categories for the audit include: management responsibility, maintenance systems and procedures and personnel and resources. This is a maintenance business review which reviews the maintenance and considers it as a business.

An equipment condition assessment is provided. Assessment is made of information correctness, housekeeping, physical and mechanical condition, mounting and base condition, vibration levels and insulation. Both in-service equipment and spare parts are evaluated. The Equipment Condition Assessment is designed to provide a formal, structured and cost efficient way of assessing the physical, mechanical and electrical health of the plant equipment. Equipment is reviewed at to determine if it is critical. Standardized tests and inspections are utilized and a numerical value is assigned for use in trending and comparison.

According to the invention, computerized maintenance solutions offer an efficient maintenance operation using computers to plan, schedule and record maintenance work. The computers run software for such tasks which is also capable of handling materials management and spare parts logistics. The success of the computerized maintenance management system relies on activities such as design, selection, installation, population and staff training. Populating the software with the data from the planning phase requires a significant man-power effort. Under the present invention, this manpower effort is provided as a service to the customer in a combined maintenance and information technology function. In a preferred development, the provider has at hand intensive understandings of special applications and relevant industrial experience, and works hand-in-hand with the maintenance provider. One aspect of the computerized maintenance solution is to deliver and implement interfaces to the enterprise resource planning system of the customer for purchasing an access control systems, materials and document management systems and condition monitoring systems.

As a result of these advances, the business strategy of the customer takes into account the ongoing changes resulting from globalization, technical advances and increasing competition. Best maintenance practices help reduce costs, increase plant availability, and improve product quality.

An additional basic module mentioned above is the inventory management services. The module offers the customer a physical count and identification, an inventory optimization analysis, and segregation and verification. The count and identification feature helps to identify recorded inventory, identify unrecorded inventory, collect nameplate data, and update the database. A visual inspection can also be performed as part of the inventory process. The inventory optimization and reduction delivers to the customers the benefits of reduction in inventory investment and carrying costs, release of the value contained in the redundant inventory, a reduction of inventory maintenance and occupancy costs. It also releases the storage space occupied by the unneeded inventory for other uses. A positive cash flow results. A verification procedure is used to reduce risks of premature failure of required inventory. The segregation separates required from redundant inventory and permits the customer to verify that its required inventory is ready for active service duty. A benefit is that the customer may purge the redundant inventory.

Energy optimization is implemented by a complete system review which results in optimization recommendations with the objectives of energy savings and reducing variance in monthly energy costs. Under the routine operational check module, daily monitoring of operational system parameters and review of work process efficiency is provided.

A shared inventory module as mentioned above, the inventory review to identify potential inventory sharing partners. A facility consensus on common repair specifications and inventory levels. Excess inventory can be liquidated. Storing, maintaining and managing of a shared mutual inventory is provided. The shared inventory benefits include reduced inventory investment and carrying costs, reduced storage, maintenance and occupancy costs. It releases the value in redundant inventory, effecting a positive cash flow. A reduction in the number of premature equipment failures due to storage and maintenance practices is also realized. This also provides a forum to discuss other mutual sharing opportunities.

A high end modules in further detail include the following: A contract is prepared for agreement between the customer and provider. Task sheets or maintenance schedules are prepared outlining the scope of the work, and estimates of costs are prepared.

A commercially focused strategy is adopted and a performance based relationship is established between the customer and provider by which the provider accepts some calculated risk. This is different than a time and materials maintenance agreement. In addition to accepting equipment and materials costs, the provider may also accept risks at to labor costs.

The performance contracting option features tangible value-added evaluation systems, key performance indicators, a third party validation of asset review, and scheduled reviews. Risks are minimized while the provider and customer enter into a win/win relationship using a performance based fee, at least in part. This could depend not only on the maintenance performance but also on the market condition for the plant. Effectiveness is provided through measured criteria.

The high level option of full coverage features asset review and equipment placement. This provides the customer with predictable costs, equipment replacement including labor over the term of the contract, and reduced inventory. These high level options are focused on prevention, prediction, correction, inspection, and detection under the umbrella of business based maintenance.

The present invention is applicable to technical maintenance situations for a variety of businesses, including e-business (electronic business). On line ordering of parts or services is considered in this regard. The present invention is also particularly useful for B-to-B (business to business) companies.

As a feature of the performance based contract, a guarantee may be included to specify an up-tine for the on-line service. For instance, the conditions of the contract may specify a 98 percent up time for the on-line service being served by the present method.

A further high level option available to the customer it to offer financing for equipment that is being serviced under the present method.

Thus, the present invention offers customized outsourced technical services to a customer. These are related to the business strategy of the customer. The method of the present invention provides that the technical services provider becomes aware of the customer needs and then offers a modular service package tailored to the needs of the customer. Each solution for each customer is different. Different combinations of the modules are offered depending upon the customer's needs. This has a greater benefit for the customer.

Complex plants and facilities are serviced according to the present invention.

Under the present invention, a business based maintenance is provided following a comprehensive approach with results oriented equipment management. Business needs are identified and then a tailored packages of services are developed to meet defined objectives. An efficient partnership is formed between the customer and maintenance services provider which is focused on a win/win outcome. The key performance indicators provides strength to performance based contracts by checking such things as availability, cost reductions, and safety. A shared profitability enhances the ownership of the customer and is a key strategy for management and employee success.

The objectives of the programs are to maximize equipment and system reliability, optimize return on maintenance expenditures, reduce inventory investment, and improve cost avoidance. Basic modules provide a base and are technology oriented and cover basic maintenance needs. Atop the basic modules are high end options which take the customer to a business based maintenance solution tuned to the special needs of the business. The basic modules of the technical support program are designed to ensure that maintenance issues are detected and addressed at their earliest stages. This increases reliability as well as availability of power generation and distribution equipment and systems, automation systems, drive systems, control and instrumentation systems as well as information technology systems. The result is that the bottom line dollars of the business will increase.

An aspect of the present invention is to provide a technical support program. The business strategy of the customer is taken into account in ongoing changes as a result of globalization, technical advances and increased competition. The technical support program is a part of the strategy to develop business based maintenance. A broad range of maintenance services are offered which are designed to provide comprehensive vendor-independent solutions. The benefits of the technical support program are increased equipment reliability and availability, reduced costs through a pro-active business based maintenance approach, minimized down time, optimized asset management, capital solutions, and fast response when and where the customer needs it.

By offering the modular service packages, the technical support program the modular tailors the maintenance improvements to the budget of the business and to the business objectives. Benefits are provided including a reduced cost through proactive business based maintenance, a minimized downtime, an optimized asset management including capital solutions and a fast response when and where the customer needs it.

The business based maintenance is a process that defines the equipment and maintenance needs in terms of the business goals of the customer. A uniquely tailored maintenance strategy has been developed to help the customer reach their objectives. Working with the maintenance organization, the providers engineers and maintenance specialists have assessed the current situation and developed strategies based on the plants specific requirements. By working closely with the employees of the company, sustained improvements are achieved which leads to success.

In one aspect of the invention, the provider of these services is a manufacturer of products and systems as well as plants, and is a maintenance services provider with know-how. Such a provider offering modular services according to the present invention can keep the plant fully operational and the equipment up to date. A significant feature of the present invention is that the services are vendor independent.

The objectives of the program are to maximize equipment and system reliability, optimize return on maintenance expenditures, reduce inventory investment, and improve cost avoidance. Basic modules provide a base and are technology oriented and cover basic maintenance needs. The high end options take the customer to a business based maintenance solution tuned to the special needs of the business. The basic modules of the technical support program are designed to ensure that maintenance issues are detected and addressed at their earliest stages. This increases reliability as well as availability of power generation and distribution equipment and systems, automation systems, drive systems, control and instrumentation systems as well as information technology systems. The result is that the bottom line dollars of the business will increase.

The best maintenance practice of the present invention puts the customer ahead of his competition allowing the customer to focus on his core business. Increased equipment availability and reliability are provided, while aligning maintenance to the business strategy of the customer and reducing maintenance costs. Eliminating the cost of unplanned shutdowns and optimizing asset management is also another advantage of the present invention.

Thus, customized maintenance services are provided for a business covering every type of plant and equipment irrespective of manufacturer or technology. Worldwide support facilitates success in the application of the present method.

The FIG. 15 also illustrates a process for offering motor services to a customer is shown, including first a pre-screening 10 at the first contact with the customer. Included in this pre-screening is a first contact questionnaire to the prospective customer and discovery of information about the prospective customer via the Internet, and other sources.

In a second step, customer needs are discussed 12, which covers finding out what the customer needs, answering a questionnaire directed to the motor services program, which is done through several meetings. A letter of intent 14 is prepared to establish a consensus to consider the motor services program. These first three steps in the process provide tests of the customer's commitment to proceed.

The next step is to determine the needs and priorities 16 of the customer. Priority areas for improvement are identified. As a tool to identify these, a motor management review having, in one embodiment, 9 aspect areas, might be performed using a questionnaire. Topic areas are set forth for example in tabular format and the questioner observes and asks questions to determine the answers to the questions. The questions are also divided into Five levels to identify a sophistication level of the prospective customer's technical and motor maintenance services, systems and procedures.

As a further step 18, a motor management program proposal is prepared and presented to the prospective customer. This is done with reference to the menu of modular services and options, which will be discussed later. This menu is also referred to as a program structure. As an important part of the proposal 18, the goals of the business are considered, an implementation plan is developed, a contract structure is determined, a return on investment is studied, and key performance indicators are identified.

These same aspects are considered during the negotiation and execution of the contract 20. Once the contract is made, the outsourced motor services arc implemented at 22. A business based maintenance or BBM analysis is performed. An motor condition assessment is performed. Motor conditions are assessed, and a CIP is implemented. The implementation 22 of the motor services program also utilizes a menu of services.

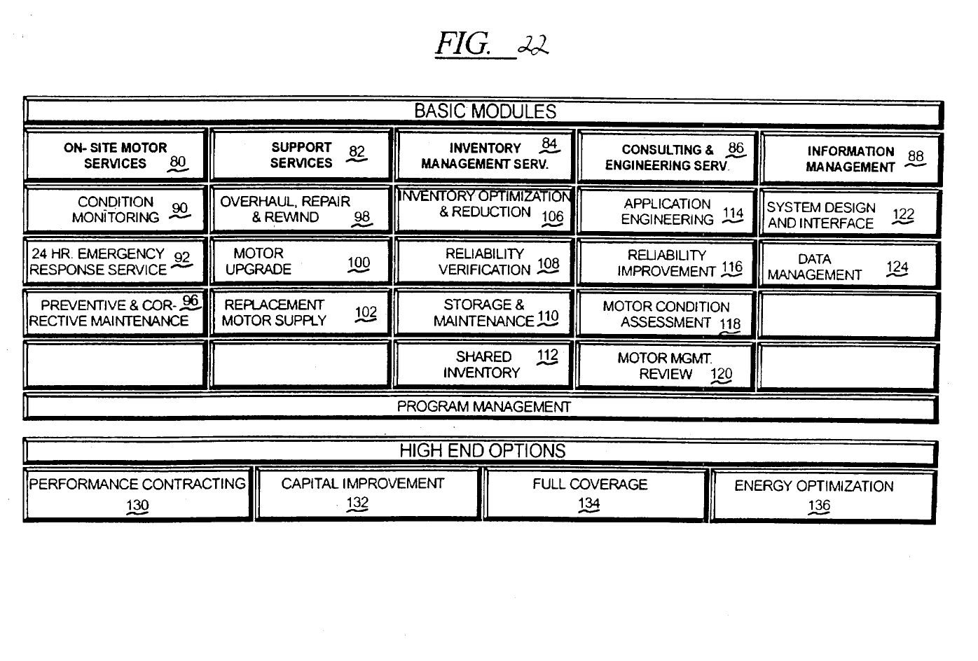

A design model is shown in FIG. 21 for the present motor management program. At first a customer may be unaware of opportunities for improvement at 30. During the motor management review 32, the customer recognizes the opportunities 34 and prioritizes the areas for improvement at 36. As a first phase 38 the condition assessment 40 is performed by gathering information 42. A feasibility study is conducted at 44 and a customized solution 46 is proposed to the customer. Implementation 48 of the service often yields information that can be used for improvement and so these aspect are fed back to modify the customized solution in a continuous improvement process 50.

In a second phase 52, a reliability verification 54 is performed by gathering information 56. A feasibility study 58 is conducted that leads to a customized solution 60. As before, when the solution is implemented at 62, ways to improve the process are discovered and these are fed back to the solution in a continuous improvement process 64.

Virtually all of a customer's motors will fall serviceable under the present motor management program. The customer has certain core competencies relating to its core business that these should be left to the customer to address, however, the various technical aspects of motor maintenance that play a supporting roll in the plant's production may each be addressed by the present invention by selection of modules from the menu of FIG. 21

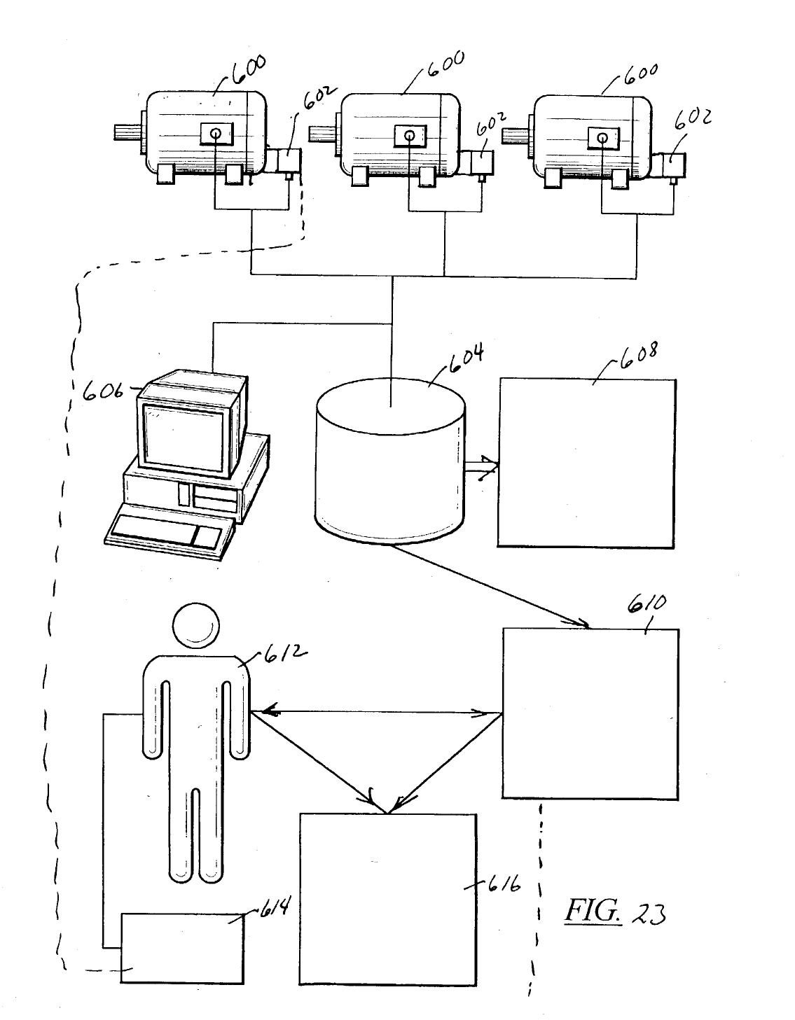

FIG. 22 illustrates the modular services offered according to the motor management program of the present invention. These modular services are provided as a menu of services.

The upper portion of the menu sets forth the basic modules of the motor services. These are divided into five aspects, including on-site motor services 80, support services 82, inventory management services 84, consulting and engineering services 86, and information management 88. The on-site service modules 80 include condition monitoring 90, 24-hour emergency response service 92, and preventative and corrective maintenance 96. Under support services 82 are provided overhaul and repair and rewind services 98, motor upgrades 100 and replacement motor supply 102. The inventory management services 84 provide modules for inventory optimization and reduction 106, inventory reliability verification 108, storage and maintenance 10, and a shared inventory module 112. The consulting and engineering services 86 application engineering 114, reliability improvement 116, motor condition assessment 118, and a motor management review 120. The class of modules relating to information management 88 provide a system design and interface module 122 and a data management module 124.

Not only are there basic service modules but the present invention also provide high-end modules as shown at the lower portion of FIG. 22. The first such high end module is a performance contracting module 130. This is followed by a capital improvement module 132, a full coverage module 134 and an energy optimization module 136.

The outsourced motor service provider and/or the customer looks to these menus to discover modules that best fit the customer's needs. For example, the customer may choose a storage and maintenance module 110 and the 24 hour emergency response module 92 along with other modules.

Once the modules are chosen they are implemented, for example, as shown in the FIG. 18. The implementation begins with the development of a maintenance strategy 140. The maintenance strategy development requires a business plan evaluation 142, an operational analysis of the plant 144, a critically analysis 146, a motor identification 148 and a motor failure analysis 150. The maintenance strategy 140 is followed by defining motor maintenance plans 152. According to the invention, the maintenance plan 152 development includes defining a hierarchical plant index 154, determination of key performance indicators 156 for the plant, the assignment of criticalities 158 for the motors, performance of a failure analysis 160, and assignment of maintenance actions 162.

The plan 152 is the foundation for the maintenance management 164 wherein standard jobs 166 are used for tasks due 168 on work orders 170 and requested work 172. The work orders 170 lead to a work schedule 178. From the management 164, the maintenance work 180 is performed by work groups 182 until the work is completed 184. The completed work feeds back into a work history 176. The work history 176 is provided for a motor register 174, which is a hierarchical plant structure of the company within which the standard jobs 166 are performed.

The maintenance management part 164 is subject to analysis and review 186 according to this invention. Historical data is reviewed, failure analysis is reviewed. A review is made of safety issues, employ statistical techniques to evaluation frequency of work and employ reliability engineering techniques to evaluate design out requirements. These can lead to an altering of the maintenance plan 188. For example, modification of the quality maintenance plan is done by failure analysis, review of maintenance actions, frequency of work, duration of work and by entering new motors. Alterations of the maintenance plan is part of the continuous improvement cycle.

Motor services according to the present invention is involved in a plant during much of the plant's history. For example, as shown in FIG. 5, a plant is constructed at 198 and early on the motor services has only a small involvement as indicated at 200. Just prior to commissioning of the plant at 202, the sharp upswing in the motor services curve indicates increased involvement. After commissioning 202, the operation 204 of the plant provides a foundation on which is built the condition based inspection and preventative maintenance services 206 of the invention. Overlying the inspection and preventative maintenance services 206 is repairs 208 made to the motors of the plant during its lifetime. These may fluctuate particularly under the processes of the prior art, but under the continuous servicing provided by the present invention, the repair involvement is steady. Over this is the modernization potential 210 realized by motor modernization projects. This leads to technical innovation as indicated by the increasing height of the line. The time line of involvement of the motor maintenance program ends at the decommissioning 212 of the plant.

As illustrated in FIG. 20, through the application of the present invention, the business objectives of a customer 214 come into alignment 216 with the business objectives of the service provider 216 under the performance based contract 220. Thus, the motor management program is a modular service package that tailors the maintenance improvements to the budget of the business and to the customer's business objectives. An important aspect is that the modular service package leaves the core competencies to the business. Benefits are provided including a reduced motor maintenance cost through pro-active business based maintenance, a minimized motor downtime, an optimized asset management including capital solutions and a fast response when and where the customer needs it.

In further detail, the modules offered under the basic services include a condition monitoring program 90. Using state of the art methods to assess the condition of the plant and the machinery such as thermography, vibration measurements, ultrasonic testing, partial discharge testing, oil and fluid analysis, and technical endoscopy, advanced warning of problems is provided.

An aspect of the present motor services is that emergency calls costs are covered by the agreement at no added expense to the customer under the emergency response module 92.

In undertaking the motor management program, the motor management review has been performed. This identifies improvement potentials so that measures can be derived from that review to improve the motor maintenance effectiveness, based on the implementation of a continuous improvement process. The goals are to provide short-term recommendations focused on the development and implementation of a Maintenance Quality Improvement Plan and provide short-term recommendations focused on the development and implementation of a Maintenance Quality Improvement Plan.

An audit or review is performed using a standardized approach and objective assessment techniques. Categories for the audit include such as motor condition monitoring and predictive maintenance, motor repair procedures, motor reliability improvement, motor information management, etc.

An motor condition assessment 118 is provided. Assessment is made of information correctness, housekeeping, physical and mechanical condition, mounting and base condition, vibration levels and insulation. Both in-service motors and spare motors are evaluated. The Motor Condition Assessment is designed to provide a formal, structured and cost efficient way of assessing the physical, mechanical and electrical health of the plant's motors. Motors are reviewed at to determine if it is critical. Standardized tests and inspections are utilized and a numerical value is assigned for use in trending and comparison.

According to the invention, computerized maintenance solutions offer all efficient maintenance operation using computers to plan, schedule and record motor maintenance work. The computers run software for such tasks, which is also capable of handling materials management and spare parts logistics. The success of the computerized maintenance management system relies on activities such as design, selection, installation, population and staff training. Populating the software with the motor data from the planning phase requires a significant manpower effort. Under the present invention, this manpower effort is provided as a service to the customer in a combined maintenance and information technology function. In a preferred development, the provider has at hand intensive understandings of special motor applications and relevant industrial experience, and works hand-in-hand with the motor maintenance provider. One aspect of the computerized maintenance solution is to deliver and implement interfaces to the enterprise resource planning system of the customer for purchasing an access control systems, materials and document management systems and condition monitoring systems.

As a result of these advances, the business strategy of the customer takes into account the ongoing changes resulting from globalization, technical advances and increasing competition. Best motor maintenance practices help reduce costs, increase plant availability, and improve product quality.

An additional basic module mentioned above is the inventory management services 84. The module offers the customer a physical count and identification, a motor inventory optimization analysis, and segregation and verification. The count and identification feature helps to identify recorded motor inventory, identify unrecorded motor inventory, collect nameplate data, and update the database. A visual inspection can also be performed as part of the inventory process. The motor inventory optimization and reduction 106 delivers to the customers the benefits of reduction in inventory investment and carrying costs, release of the value contained in the redundant inventory, a reduction of inventory maintenance and occupancy costs. It also releases the storage space occupied by the unneeded motor inventory for other uses. A positive cash flow results. A verification procedure is used to reduce risks of premature failure of required motor inventory. The segregation separates required from redundant motor inventory and permits the customer to verify that its required motor inventory is ready for active service duty. A benefit is that the customer may purge the redundant motor inventory.

Energy optimization 136 is implemented by a complete motor system review, which results in optimization recommendations with the objectives or motor energy savings and reducing variance in monthly energy costs.

A shared inventory module 112, as mentioned above, is based on the inventory review to identify potential motor inventory sharing partners. A facility consensus on common motor repair specifications and motor inventory levels. Excess motor inventory can be liquidated. Storing, maintaining and managing of a shared mutual motor inventory is provided. The shared motor inventory benefits include reduced motor inventory investment and carrying costs, reduced storage, maintenance and occupancy costs. It releases the value in redundant motor inventory, effecting a positive cash flow. A reduction in the number of premature motor failures due to storage and maintenance practices is also realized. This also provides a forum to discuss other mutual sharing opportunities.

High-end modules in further detail include the following: A contract is prepared for agreement between the customer and provider. Task sheets or maintenance schedules are prepared outlining the scope of the work, and estimates of costs are prepared.

A commercially focused strategy is adopted and a performance-based relationship is established between the customer and provider by which the provider accepts some calculated risk. This is different than a time and materials maintenance agreement. In addition to accepting motor and materials costs, the provider may also accept risks at to labor costs.

The performance contracting option features tangible value-added evaluation systems, key performance indicators, a third party validation of motor asset review, and scheduled reviews. Risks are minimized while the provider and customer enter into a win/win relationship using a performance based fee, at least in part. This could depend not only on the maintenance performance but also on the market condition for the plant. Effectiveness is provided through measured criteria.

The high level option of full coverage 134 features asset review and motor replacement. This provides the customer with predictable costs, motor replacement including labor over the term of the contract, and reduced inventory. These high level options are focused on prevention, prediction, correction, inspection, and detection under the umbrella of business based maintenance.

The present invention is applicable to technical maintenance situations for a variety of businesses, including e-business (electronic business). On line ordering of parts or services is considered in this regard. The present invention is also particularly useful for B-to-B (business to business) companies.

As a feature of the performance based contract, a guarantee may be included to specify an up-time for the on-line service. For instance, the conditions of the contract may specify a 98 percent up time for the motor system being served by the present method.

A further high level option available to the customer it to offer financing 132 for motors that is being serviced under the present method.

Thus, the present invention offers customized outsourced motor services to a customer. These are related to the business strategy of the customer. The method of the present invention provides that the motor services provider becomes aware of the customer needs and then offers a modular service package tailored to the needs of the customer. Each solution for each customer is different. Different combinations of the modules are offered depending upon the customer's needs. This has a greater benefit for the customer.

Under the present invention, a business based maintenance is provided following a comprehensive approach with results oriented motor management. Business needs are identified and then a tailored packages of services are developed to meet defined objectives. An efficient partnership is formed between the customer and maintenance services provider, which is focused on a win/win outcome. The key performance indicators provide strength to performance based contracts by checking such things as availability, cost reductions, and safety. A shared profitability enhances the ownership of the customer and is a key strategy for management and employee success.

The objectives of the programs are to maximize motor and system reliability, optimize return on maintenance expenditures, reduce inventory investment, and improve cost avoidance. Basic modules provide a base and are technology oriented and cover basic maintenance needs. Atop the basic modules are high-end options which take the customer to a business based maintenance solution tuned to the special needs of the business. The basic modules of the motor management program are designed to ensure that maintenance issues are detected and addressed at their earliest stages. This increases reliability as well as availability of motor systems. The result is that the bottom line dollars of the business will increase.

An aspect of the present invention is to provide a motor management program. The business strategy of the customer is taken into account in ongoing changes as a result of globalization, technical advances and increased competition. The motor management program is a part of the strategy to develop business based maintenance. A broad range of maintenance services are offered which are designed to provide comprehensive vendor-independent solutions. The benefits of the motor management program are increased motor reliability and availability, reduced costs through a proactive business based maintenance approach, minimized down time, optimized asset management, capital solutions, and fast response when and where the customer needs it.

By offering the modular service packages, the motor management program tailors the maintenance improvements to the budget of the business and to the business objectives. Benefits are provided including a reduced cost through pro-active business based maintenance, a minimized motor downtime, an optimized asset management including capital solutions and a fast response when and where the customer needs it.

The business based maintenance is a process that defines the motor and maintenance needs in terms of the business goals of the customer. A uniquely tailored maintenance strategy has been developed to help the customer reach their objectives. Working with the maintenance organization, the providers engineers and maintenance specialists have assessed the current situation and developed strategies based on the plants specific motor system requirements. By working closely with the employees of the company, sustained improvements are achieved which leads to success.

In one aspect of the invention, the provider of these services is a manufacturer of motors and is a maintenance services provider with know-how. Such a provider offering modular services according to the present invention can keep the motor system fully operational and the motors up to date. A significant feature of the present invention is that the services are vendor independent.

The objectives of the program are to maximize motor and system reliability, optimize return on maintenance expenditures, reduce inventory investment, and improve cost avoidance. Basic modules provide a base and are technology oriented and cover basic maintenance needs. The high end options take the customer to a business based maintenance solution tuned to the special needs of the business. The basic modules of the motor management program are designed to ensure that maintenance issues are detected and addressed at their earliest stages. This increases reliability as well as availability of the motor system. The result is that the bottom line dollars of the business will increase.

The best maintenance practice of the present invention puts the customer ahead of his competition allowing the customer to focus on his core business. Increased motor availability and reliability are provided, while aligning maintenance to the business strategy of the customer and reducing maintenance costs. Eliminating the cost of unplanned motor failures and optimizing asset management is also another advantage of the present invention.

Thus, customized motor maintenance services are provided for a business covering every type of motor irrespective of manufacturer or technology. Worldwide support facilitates success in the application of the present method.

A further objective of the present invention is to provide fitness for plants which permits the plants to run faster, longer and better. In this regard, the invention provides plant maintenance and auxiliary process management. Other aspects provide general contracting, on-call and logistics service, information technology industry solutions, electronic manufacturing services, and knowledge management, all under the umbrella of industrial services.

The invention is accomplished by maintenance outsourcing. It uses a structured approach, unique processes and procedures, individually customized solutions, defined agreed maintenance strategies, thereby reducing complexity, adding greater focus and improved performance and a reduced cost. As a result, performance is increased while at the same time costs are decreasing, thereby increasing profit.

Utilization of the present method of business based maintenance improves performance so that plant profitability is increased by 10-50% and maintenance costs are reduced by 10-30%. The present invention is finds utility in a range of industries, including automotive plants, chemicals, mining, postal services, pulp and paper, steel, and water treatment.

The present invention provides integral plant maintenance with world wide support, with maintenance services just a phone call away at, for example, 296 locations in 69 countries.

According to the present method, the customer comes together with the provider in an alignment to move toward business objectives through a performance based contract. The business objectives of the customer are considered, then a unique package is developed to meet those objectives. The strategy development creates a partnership focused on a win/win outcome for both parties.

Performance-based contracts are used to reinforce the alignment between the parties and ensure the win/win outcome. The performance based contracts form an integral part of the partnership. In this arrangement, the rewards to the contractor are measured by key performance indicators and reflect the success of the relationship. The nature of the key performance indicators will depend on the type of the contract and the objectives of the business and are agreed in consultation with the customer. On a total outsourced contract for integral plant maintenance, these can include safety, plant availability, and reduced operating costs. The weighting of the individual components depends on their importance to the customer's business.

The present invention utilizes what is referred to as a fitness plan. First, a business plan is developed, which aligns maintenance to business objectives. It is developed at the executive level and communicated to all. Next, a maintenance policy is developed, which establishes the rules for carrying out maintenance it is set jointly by production, engineering and maintenance. After that, a maintenance improvement strategy is developed, which determines jointly the strategies required to improved plant performance and reduce costs. An organization step is provided, wherein is established the optimal organization to meet the plan while minimizing overhead. Key performance indicators are developed that measure performance against key requirements. Lastly, benchmarking is performed to measure performance against competitors and others. Thus, the present invention provides a six step approach to implementing a fitness plan to a plant.

Using the present invention results in a shift in reliability. Instead of reactive maintenance which goes into operation when there is a breakdown taking a firefighting mode of operation with inadequate preventive and predictive maintenance plans, the present invention takes a pro-active reliability approach, with preventive schedules and a high degree of planning and scheduling. Predictive maintenance technology and analysis is utilized instead of a high degree of unscheduled maintenance. Rather than short term strategies of less than one year, long term maintenance improvement strategies are developed. Whereas insufficiently trained personnel have been used in the past, well trained personnel are now put to the job. Cost predictability goes up, inadequate systems are replaced, root cause failure analysis is performed, detailed measurement and reporting replaces the inadequate reporting, and a strong leadership is put in place. This results in both an increase in productivity and an increase in reliability.

Real bottom line results are delivered, including increased capacity from existing fixed assets, reduced costs both for production and maintenance, improved on-time delivery of products and reduced inventory.

To assist a customer in determining where they are in the reactive/pro-active maintenance scale, a maintenance business review is conducted, either after a strategic overview or an in depth analysis. The outcome of the review is used to determine how to proceed.

Thus, the present invention provides a systematic approach The right tools for the right job are provided. The business plan, the maintenance policy and the improvement strategy inputs are linked to the actual plant components to produce the maintenance plan. The plan forms the basis of the maintenance management system. It defines maintenance actions, frequencies and methods for every part of the plant.

The present invention permits the customer to choose the package that best suits the customer's needs, from total outsourcing through to individual specialist services. Integral plant maintenance is provided by total outsourcing of, for example, electrical equipment, mechanical equipment and plant building, including: strategy development and optimization, predictive condition-based maintenance, preventative maintenance, corrective maintenance, planned shut-downs, spare parts management, labor management, maintenance management systems implementation and optimization. All of these are aligned to the customers needs through performance based contracts.

The integral plant maintenance not only includes the plant maintenance packages that meet the customers' needs in any combination of predictive and preventative maintenance, corrective maintenance, and planned shut-downs, but also utilize specialist services. The specialist services take advantage of the expertise of the provider including: condition monitoring, vibration, thermography, ultrasonic, oil analysis, motor current, and alignment; as well as on call services for equipment malfunction; reconditioning services for motors, switch gear, transformers, compressors and other equipment; diagnostics and testing from high voltage to electronic circuitry; logistics and spare parts management which minimize working capital; decontamination services for electronic PCB's and electrical equipment; and motor management which provides logistics and spare parts management, maintenance, energy reduction, and even financing packages.

This allows a customer not only to compete at the highest level for an extended period by not only having superior skills but also reliability of performance. This requires a clear goal, a training plan with an improvement strategy to keep ahead of the competition, along with a support team and a measure of the customer's and their competitors performance.

In addition to plant maintenance, the present invention also provides auxiliary process management, electromechanical components and switchgear maintenance, infrastructure installation maintenance and power plant maintenance.

Since every structure needs a strong foundation, maintenance is no exception. The foundation as shown in FIG. 3 constituting support packages that provide benefit to the customer. The support packages include maintenance management which provides strategy development and optimization, policy development, and systems. A maintenance business review is a further support package through which a bench mark of the current organization is performed and used to build an improvement plan. Know-how is a support package which ensures that best practices and experience are shared by establishing an Intranet based information network.

As a further component of the support packages, maintenance technology provides the latest technology in condition monitoring, online sensors, and decision analysis tools. Training is performed at all aspects of maintenance. A further foundational element is financial control and reporting, which provides prompt, comprehensive analysis of past performance and future projections. Lastly, the human resources support package provides for employment and management of the people performing the maintenance operations.

The foregoing support packages provided to the customer enables the customer to benefit from worldwide experience of the provider in a wide range of industries.

All aspects of maintenance work are supported according to the present invention. Maintaining an industrial plant requires a combination of skills and resources to meet the varying needs of the business. For instance, day-to-day first-line maintenance including emergency corrective work, cleaning, adjusting and monitoring of plant health is provided. Routine planned maintenance on a corrective, preventative, predictive and reliability basis are also provided, as well as major outages for plant overhaul or modifications.

Thus, the present invention provides customized solutions to meet the needs of the customer. This includes the use of the customers own operating personnel to carry out all or part of the first line including inspections, lubrication and other activities as part of a total plant management based philosophy.

The present invention can be used in car manufacture, chemical production, gas processing and collection, mining, nuclear research, oil and gas industries, open cut coal mining, paper manufacturing, parcel handling centers, cold rolling steel mills with processing lines, telecommunications, thermal power stations, and water and sewage treatment. The present invention is versatile in that it provides custom designed integrated maintenance services covering every type of plant and equipment, irrespective of manufacturer and technology involved. According to the present method, full responsibility for maintenance of all or just part of the plant is taken, emergency services are provided to compensate for work force shortages and breakdowns, specific plants and machines are operated and maintained, and maintenance consulting and optimization is provided.

The business solution provided by the present maintenance organization is tailored to the needs of the customer and can utilize the resources of the provider or integrate those provider resources with the existing work force into a new structure. A teal-n-based organizational structure ensures full involvement of all personnel. Reward schemes are utilized for employees which are aligned to the performance based structure for the business as a whole so as to ensure a common focus throughout the whole team.

Under the present method, a pool of experts is available to provide the customer with the best practice know-how derived from many projects within a company. High performance communications systems are mobilized with expert knowledge of many skill centers operated throughout the world.

Motivated teams of workers are allowed extensive autonomy through a flat organizational structure so that a high degree of customer focus is provided with bench marks that set key performance indicators which in turn characterize the way the maintenance personnel approach their work.

Proven maintenance strategies are utilized to move from a reactive to a proactive maintenance approach. A maintenance management system is set up that will improve analysis and reporting providing a performance plus factor. Innovative diagnostic tools include the use of state of the art measurement and diagnostic systems which enable the accurate identification of the condition of the plant and its machinery.

The provider of the maintenance services view maintenance as a core business, providing a core competence in the field that yields a quicker implementation.

According to the invention, individually customized contracts may define the extent of the services to be provided, the transfer of staff, the performance related bonuses, define responsibility for plant operations, and even include sale and leaseback schemes for transfer of subplant and warehouse stocks. Spare parts distribution and after sales service are also available in an international distribution network of replacement parts which are available on an urgent need basis in the event of breakdown. Service centers are open twenty-four hours a day every day of the year in countries throughout the world

Flexible organization structures are utilized in plant automation through knowledge of typical technologies in use irrespective of manufacturer. Specialization outside the experience of the provider taps other specialists outside the company, preferably local specialists.

Electromechanical Maintenance

The present invention provides electromechanical maintenance as one aspect of the maintenance services offered according to the present invention. Under the invention, maintenance is an investment to be optimized and not a cost to be minimized. Industrial maintenance services are offered in accordance with the present invention as single modules or as complete solutions including managerial and consulting services. The services under the present invention include maintenance business review, a maintenance improvement program, business based maintenance strategy development, computerized maintenance solutions, and asset condition review. The maintenance business review utilizes standardized procedures and assessment criteria to review and benchmark the current maintenance operation of the customer. The review covers three main categories, including management responsibility, maintenance systems and procedures, and personnel and resources. As many as twenty-two performance indicators are evaluated in detail, providing a starting point for an improvement program.

Under the maintenance improvement program, an environment of change and improvement is created in the existing maintenance department. Improvement programs are established as the result of the maintenance business review which will cut overall long term costs and improved reliability. Among the aspects of the maintenance improvement program are: aligning the maintenance strategies to the business objectives, improving planning and scheduling, optimizing workload management, improving the utilization of a computerized maintenance management system, better management of materials, and establishing a training and employee development program.

The business based maintenance strategy development aspect of the present invention is a process which first defines the critical equipment and maintenance needs in terms of the business goals of the customer. The next step is to develop uniquely tailored maintenance strategies, that will help the customer reach the customers objectives. The strategies developed are pro-active strategies which are complemented by modern monitoring technologies to improve equipment reliability and provide an impact at the bottom line of the business.

As a further aspect of the invention, an asset condition review is performed by an on-site audit of equipment to evaluate equipment condition, provide a comprehensive preventative maintenance program, implement predictive maintenance techniques, and evaluate expected equipment performance. As a further review, the asset value of the equipment, the life expectancy thereof, the spare parts availability, and replacement costs are considered.

According to the invention, computerized maintenance solutions offer an efficient maintenance operation using computers to plan, schedule and record maintenance work. The computers run software for such tasks which is also capable of handling materials management and spare parts logistics. The success of the computerized maintenance management system relies on activities such as design, selection, installation, population and staff training. Populating the software with the data from the planning phase requires a significant man-power effort. Under the present invention, this man-power effort is provided as a service to the customer in a combined maintenance and information technology function. In a preferred development, the provider has at hand intensive understandings of special applications and relevant industrial experience, and works hand-in-hand with the maintenance provider. One aspect of the computerized maintenance solution is to deliver and implement interfaces to the enterprise resource planning system of the customer for purchasing an access control systems, materials and document management systems and condition monitoring systems.

As a result of these advances, the business strategy of the customer takes into account the ongoing changes resulting from globalization, technical advances and increasing competition. Best maintenance practices help reduce costs, increase plant availability, and improve product quality.

Electro-Mechanical Maintenance

Electromechanical maintenance according to the present invention is provided as professional services with predictable costs, which increase plant availability, provide cost reductions through efficient operations and high employee motivation, benefit from worldwide best-practice know-how of the provider, gain flexibility in management and operation of the customers plant, obtain access to a global service network operating twenty-four hours a day every day of the year, and reduce expenses for administration and logistics.

Under the present invention, a business based maintenance is provided following a comprehensive approach with results oriented equipment management. Business needs are identified and then a tailored packages of services are developed to meet defined objectives. An efficient partnership is formed between the customer and maintenance services provider which is focused on a win/win outcome. The key performance indicators provides strength to performance based contracts by checking such things as availability, cost reductions, and safety. A shared profitability enhances the ownership of the customer and is a key strategy for management and employee success.

A significant feature of the present invention is the availability of maintenance modules for selection. Modular services are selected from a menu of services on the basis of those modular services which suit the customer's maintenance needs. As shown in FIG. 4, electromechanical maintenance includes maintenance consulting services these include a maintenance business review, asset and equipment audits, and work force development. A guiding principle is to know what is to know-how.

A further module available under the modular services is cleaning services. The cleaning services make the equipment more reliable. Under the present invention, cleaning services are available for dry, moist or wet cleaning, dry cleaning of high voltage electrical equipment online is provided. Cleaning of switching gear, transformers, electrical and electronic equipment is available as well. Further, decontamination and corrosion removal is one aspect of the cleaning services module.

A further module is a condition monitoring program. Using state of the art methods to assess the condition of the plant and the machinery such as thermography, vibration measurements, ultrasonic testing, partial discharge testing, oil and fluid analysis, and technical endoscopy, advanced warning of problems is provided.

A maintenance improvement program may be implemented which provides a continuous improvement of processes. Plant and work force productivity programs are put in place yielding higher skills of workers, more flexibility, and improved planning. Maintenance performance indicators are defined. The workload management is optimized and better materials management is provided as well. Improved utilization of CMMS is also provided under the maintenance improvement program.

Underlying the foregoing modules are two further programs, namely the technical support program and the motor management program. These are modular service packages that tailor the maintenance improvements to the budget of the business and to the business objectives. Benefits are provided including a reduced cost through pro-active business based maintenance, a minimized downtime, an optimized asset management including capital solutions and a fast response when and where the customer needs it.

The objectives of the programs are to maximize equipment and system reliability optimize return on maintenance expenditures, reduce inventory investment, and improve cost avoidance. Two types of modules are available, as shown in FIG. 5. Basic modules provide a base and are technology oriented and cover basic maintenance needs. Atop the premium modules are high end options which take the customer to a business based maintenance solution tuned to the special needs of the business. The basic modules of the technical support program are designed to ensure that maintenance issues are detected and addressed at their earliest stages. This increases reliability as well as availability of power generation and distribution equipment and systems, automation systems, drive systems, control and instrumentation systems as well as information technology systems. The result is that the bottom line dollars of the business will increase. Under the motor management program, the basic modules include on-site services which offer proactive maintenance with preventive and predicted maintenance, planning and scheduling as well as emergency response. A further module is the support services module which optimizes motor reliability with overhaul, repair, rewinding of the motor windings and upgrade services. Another module is an inventory management service. This service includes rationalization, optimization, storage and maintenance of spare motors as well as a shared inventory program. A consulting and engineering services module is available to the customer which provides motor management assessment, motor condition reviews and reliability improvements. Yet another module is the information management module through which system design and interface is implemented as well as data management. Lastly, a program management module is offered which provides a focal point for the information management, improved tracking and reporting of performance, and establishes a modem work flow.

The high end options available according to the present invention offer additions to the management services for plant management. Among the modules offered as a high end option are capital improvement so that the present state of the assets are improved to maintain the condition and project financing. Performance contracting is available which utilizes an independent asset review, provides value added in valuation systems using key performance indicators and makes use of regular reviews to monitor the progress. Another high end option is the full coverage option by which replacement and reduction of equipment with predictable costs is provided. The equipment is replaced for free including labor over the entire the term of the service agreement.

The technical support program also provides high end options. Among those are reliability focused maintenance. This provides a proactive strategy by which an alignment to plant criticalities is made, root cause failure analysis is implemented both as condition based and as business focused. Another high end platinum option for the technical support program is routine operational checks. Daily monitoring of operational system parameters and review of work process efficiency is provided. An emergency response feature is another high end option module for the customer. Two emergency calls per year are included along with a customized response.

The motor management program of the present invention also includes a specific high end option. Energy optimization is implemented by a complete motor system review which results in optimization recommendations with the objective of project savings.

The best maintenance practice of the present invention puts the customer ahead of his competition allowing the customer to focus on his core business. Increased equipment availability and reliability are provided, while aligning maintenance to the business strategy of the customer and reducing maintenance costs. Eliminating the cost of unplanned shutdowns and optimizing asset management is also another advantage of the present invention.

The business based maintenance is a process that defines the equipment and maintenance needs in terms of the business goals of the customer. The next step is to develop a uniquely tailored maintenance strategy to help the customer reach their objectives. Working with the maintenance organization, the providers engineers and maintenance specialists assess the current situation and develop strategies based on the plants specific requirements. By working closely with the employees of the company, sustained improvements are achieved which leads to success.

In one aspect of the invention, the provider of these services is a manufacturer of products and systems as well as plants, and is a maintenance services provider with know-how. Such a provider offering modular services according to the present invention can keep the plant fully operational and the equipment up to date. A significant feature of the present invention is that the services are vendor independent.

Thus, customized maintenance services are provided for a business covering every type of plant and equipment irrespective of manufacturer or technology. Worldwide support facilitates success in the application of the present method.

Additional services offered according to the present invention are auxiliary process management, integral plant maintenance, maintenance for infrastructure installations, and power plant maintenance.

Electronic Services

The present invention also provides electronic services for customers to enable the customers to concentrate on core competencies. Outsourcing saves time and capital and releases resources. Individualized solutions to requirements of the business relating to electronics and associated services are offered so that the recipient of the services can enhance current products or embed electronic components by optimizing the functions or even turn to miniaturization by the introduction of new technologies.

The electronic services offered according to the present invention include development, design, procurement, manufacturer, testing, just-in-time logistics and repair service.

Economic state of the art solutions are provided for the electronic needs of the customer on an individually customized basis. Development and design of electronic solutions are provided in line with the customer requirements; manufacturer of electronic plug-in cards, equipment and systems are available, as are tailored service packages.

In an embodiment of the invention, the provider functions as an enhanced value partner for electronics, offering either partial or complete solutions which are oriented to the specific needs of the business. Customized solutions are built where standard solutions are not available or are of an inadequate scale. Through innovative creativity, commitment to a value enhancement partnership with mutual success prospects and a modular range of customer services lead to business success and increased profitability.

A product concept initiates the product cycle which is brought to the development and design stage and then to a component engineering step. Following PCB layout, a prototyping phase is undertaken after which procurement of the components are effected. This leads to manufacturing, followed by testing and just-in-time logistics. As a final step in the cycle, repair and spare parts services are to be considered.

Knowledge Management

Knowledge management is a further phase in the services of the present invention. By developing an employees know-how, the company gains a competitive advantage using knowledge-based services. One aspect of the present invention is to provide individually designed technical education and training programs according to the needs of the business using the latest methods and learning technologies.

Innovation cycles are becoming shorter and demand for continuing learning is increasing. An organization faces a huge challenge to keep the knowledge level up to date. It is necessary to provide practice oriented training and innovative learning methods to develop a business's know-how. One aspect of the present invention provides seminars, guided practical training, and workshops for technical know-how in engineering, commissioning, maintenance and software development. The training program offered under the present invention provides maintenance management and preventive maintenance tools, application training for automation and drives, and operator training. Using computer-based training, economical education is possible located directly at the workplace and related to the actual tasks of the employees. Online programs offer an active know-how transfer. The benefits to the business are low cost training logistics, fast access to international data bases and information networks, and permanent online coaching by experienced tutors.

Conferences are utilized to provide compact expert know-how and exchange of experiences across industries and organizational functions. Personal know-how transfer and best practice sharing between participants of the conference and the speakers is promoted, experts are brought in and their experience utilized.

In preferred developments of the present invention, general contracting services are provided, for example in the plant construction of automobile and chemical industry businesses.

Another general contracting aspect of the present invention provides project planning, design, engineering, supply, erection and commissioning of electrical equipment for water supply and sewage plants, plants or production of cement and line, breweries and dairies up to and including international turnkey contract execution utilizing regional capabilities. A service offered under the present invention is the conversion of passenger and freight ships involving planning, design, engineering, erection and commissioning of electrical equipment for newly built and modification of existing passenger and freight ships.

Damage caused by fire can be rectified according to a service offered under the present invention. Emergency installation of equipment subsequent to the damaged caused by the fire, for example in the paper industry or on passenger ships, may include the supply of all necessary equipment.

On-call and logistic services are also provided. For instance, customized service for operators of port facilities including the take over of supply of spare parts and tools has an outsourcing project. Fault elimination in the automobile industry for diverse peripheral devices from different manufacturers is encompassed within the services provided. Fault elimination for circuit breakers is performed at various voltage levels. In another example, a manufacturer of electronics may utilize the present service for fault elimination, for example of WORM drives including repair of complex mechanical equipment and control electronics. Another aspect of the invention is to provide a service for accommodating date change in software and compatibility thereof.

As part of the integral plant maintenance and auxiliary process management, fault elimination for industrial plants, infrastructure and power plants are provided. The integral plant maintenance cover corrective maintenance of individual plant areas and maintenance of the entire plant and all auxiliary plants. This includes performing electrical, mechanical and civil work with a concept of business based maintenance. This includes development of a strategy through practical implementation and management. Examples of plants which can utilize the service include paper mills, power plants, automobiles production plants, coal, iron and copper open cast mining, as well as water supply plants, airports and buildings associated with industrial plants.

To ensure the integrity of electromechanical equipment, key areas such as motors, transformers, generators, switch gear and switch plants are maintained.

Management of auxiliary services are available including media supply, logistic services and industrial facilities management. Applications of such auxiliary processes are paper industry, automobile industry with parts supply, water supply industry, government and cultural centers.

In another aspect of the present invention, information technology plant solutions are provided. Real time data banks are maintained in combination with ERP integration. For example, interfacing with existing automatic casting machines in two spatially separated works in conjunction with optimization of the production process can be accomplished. ERP system communications can be conducted on an automation level by development and implementation of an all encompassing communication concept. The ERP system and the production automation equipment can be connected in communication for example in car manufacturing facilities and metal pressing and casting shops.

Industrial networks can be implemented for example in a semiconductor factory. A further application of the present concept is re-engineering of refineries, data processing in power plants, and information technology engineering and simulation for example in an automation and distributed control system.

Examples of electronic design and manufacturing services include the provision of controls for doors and lifts whereby the development design and manufacturer of complete, ready to install electronic controls for door systems and lifts are provided. Crane controllers may also be developed, specifically the crane swing controller. A further application of the electronic services is the development and manufacture of controls for canteen and restaurant equipment. Another example is electronic components in parking ticket vending machines.

All of this is tied together with knowledge management utilizing training of operating and maintenance personnel.

Logistic services ensure that the correct parts are available for the plants at the right time and the right place., As the result of customized services, quick help for users and manufacturers are insured. Logistics and on-call services are available twenty-four hours a day every day of the year.

Another aspect of the present invention is the business based maintenance as a mutually agreed concept for maintenance and management of secondary processes based on business objectives. This is useful for industrial, power and infrastructure applications. Services are provided not only for systems and plants of the provider but also for other equipment and facilities of all manufacturers.

IT solutions which are independent of manufacturer and system are tailored to the needs of the customer. Intelligent software for complex systems are customized and provided with associated data interfaces to provide all encompassing solutions between the EPP and the automation level. The information technology infrastructure can also be supplied if necessary.

Another component of the present invention is the provision of electronic design and manufacturing service for embedded electronics. Not only does the provider offer electronic plug-in cards, equipment and systems, but the provider also offers all encompassing solutions. Such complete solutions guarantee safety and reliability. Value added activities are optimized using a highly individualized approach, maximum flexibility and by tapping available synergy potentials.

A further advantage of the present invention is to develop employee know-how by designing technical education and training programs that are individualized according to the needs of the customer using the latest methods and learning technologies.

In the general contracting component of the present invention, experienced plant experts assist in offering professional management in all stages of a project, from initial planning and design through hardware and software engineering to erection and commissioning of the plant. The present invention provides that the provider is a solution partner with technical project experience encompassing an entire spectrum and having deep rooted knowledge of different production methods. Solutions are developed for the individual customer which are capable of meeting future challenges. Maximum economic efficiency and openness to future developments is provided by modem field-proven methods and technologies Local knowledge and a global strength are one aspect of the invention in particular. Specialists who are equipped with well grounded technical and branch specific know-how are used to develop solutions that are precisely tailored to the businesses needs. Integrating existing systems and customer-specific standard and regulations with relevant national standards and quality standards is also encompassed within the services provided.

General Contracting

In more detail, the general contracting provided under the present invention provides many solutions from a single source. Construction and/or modernization of plants and systems are met by five requirement oriented service lines. In particular, planning design and engineering of plant sections or complete plants, feasibility studies, production of software, hardware design and configuration, production of requirement specifications, production of product specifications, plant optimization, documentation, analysis of economic efficiency and productivity are all provided under this service line. Erection of the plant includes installation of pipe work and components, special construction work including mechanical equipment, construction engineering, site management, construction supervision, project management, documentation, as well as disassembly and disposal services, modernization, purchasing, logistics and transport. A service line is also offered for commissioning of plants, wherein hardware and software testing, hardware and software commissioning, startup, optimization, simulation and plant testing, project management and coordination with other works, documentation as well as training of the operating staff are available services under this service line.

Customer services management is available in coordination with third party works and with technical customer services of the provider. For example, in conjunction with a contract for purchases of electrical equipment, mechanical equipment, pneumatic equipment, hydraulic equipment, etc., a project management approach to customer services is provided.

The provider of the present invention offers turnkey production and supply of plant sections or of complete plants, branch specific solution packages with integrated software modules extending from automation through production control to the ERP/SAP level thereby providing vertical integration of the plant relocation and covering all areas from raw material acceptance to the finished product, a horizontal integration.

In a workshop line, engineering, construction and manufacturing of switch gears for power distribution and automation and drives is featured.

According to the present method, the provider accepts technical and commercial responsibility for the complete projects. Clarifying interfaces to components and coordinating all parties involved in a construction process, a functional performance of the plant is assured. Further, the provider operates within the framework of a specified cost, and agreed time schedule and an expected quality.

Thus, the solution offered according to the present method fits the goals of the business for economic efficiency and suitability to the individual plant to allow incorporation of future developments. Planing and control of production, automation of procedures, monitoring of secondary and auxiliary processes are all provided. Formulas are defined, contracts are managed, and production data are acquired so that quality can be tested and verified. In the present method, the provider works with the business in cooperation to produce suitable solutions and integrated systems throughout the entire life cycle of a plant. Such cooperation succeeds on the basis of experienced branch specialists who are available as competent partners in the vicinity of the plant, availability of technical specialists for automation, drives, power, instrumentation and information technology on a worldwide basis.

The on-call and logistics component, in detail provides custoner oriented services for users and manufacturers of technical products, systems and plants that are manufacturer independent. A high availability is strived for with the lowest possible down times and failure times of the products systems and plants which is a key precondition for economic operation of the equipment. As a first component, the field service provides fault elimination on the spot. Specialists having the necessary technical know-how come to the site to solve specific problems. Short arrival times and fault clearance times are provided in conjunction with closely meshed service center networks at the plant site. Another component is a repair service which remedies breakdowns and defects in electronic and electromechanical products, components and systems through globally distributed certified repairs centers. In-house repairs are performed as well as modifications to hardware and software according to customer-specific requirements.

An on-line service provides direct help through specialists communicating directly with the technical plants via telephone and data networks or satellite links. Detection of faults is possible in the shortest time and location of the source of the faults is provided. In one example, software faults are cured by interactive transfer of programs and data.

Without the right spare parts and the right tools, qualified service cannot be performed. For this reason, logistics services are a further component of the present invention. Logistics services speed customer service missions through selective professional procurement and hold the required materials in readiness. This reduces service times and costs by intelligent linking of information logistics and warehouse management.

The individual service packages discussed above offer a wide range of customer services in addition to fault elimination. Individual service packages are defined in which various services are precisely tailored to the customers specific requirements. A case-by-case determination provides for selection of individual service packages or within the framework of a service contract. Outsourcing assistance is provided as well as accepting complete responsibility for some processes as a way to reduce or sustain processed costs.

Integral Plant Maintenance and Auxiliary Process Management

Since plant availability is of decisive importance in view of the large capital investment in production facilities, an integrated approach to plant maintenance is desirable. The present invention provides a practice-oriented concept for plant maintenance and operational control. This concept in addition to providing technical solutions also takes into account the economic aspects of maintenance and contributes to the business goals. Integration of maintenance planning and services results in a systematic increase in plant availability as well as production quality. Resolving the conflict bet ween maintenance costs and failure costs on one hand and optimizing frequency of detection, preventative and corrective maintenance on the other hand results in an increase in bottom line profits. For industry, energy and infrastructural applications, the present services keep electrical, mechanical and civil works up to date. The present invention is focused on industrial plants, infrastructural installation, power plants, electromechanical equipment, and auxiliary process management.

Through utilization of performance based contracts, the alignment between the provider and customer is reinforced and ensures a win/win outcome. The performance based contract for an integral part of the partnership between the provider and the customer. The rewards to the contractor are measured by key performance indicators and reflect the success in the relationship. The nature of the indicators depends on the type of the contract and the objectives of the business and are agreed in consultation with the customer. Possible key performance indicators include plant availability, production quality, reduced operating costs, and safety. In the present invention, every process is important. Even processes which are not directly related to production have a major bearing on plant availability. Such auxiliary processes are covered by a business based maintenance concept. Using clearly defined cost basis analysis, ensuring production at a full running operation in an absence of external disturbances and making a contribution to high plant earnings is possible. This permits the customer to concentrate on the core business.

Information Technology Plant Solutions

Under the present invention, best of breed products and systems are integrated and networked to achieve higher performance and availability at all levels of the customers plant. Examples of technology based information technology solutions are found in food stuffs, drinks and tobacco industry, the petroleum and petrochemical industry, the metals industry, the paper industry, pharmaceutical and specialized chemical industries, infrastructure, the production industry and power generation and distribution industries.

The present method strives for efficient plant design by providing all encompassing solutions for all functions between the management and the automation level of the plant. Creation of information technology innovations is by combination of branch specific technological know-how with information technology confidence. This results in more effective plant design so that planning can take place easily quickly and at a lower cost.

The present information technology services offer industry specific packages, referred to as branch suites, industrial consulting services, integration solutions, process technology optimization, simulation, information technology based engineering, industrial data management, and industrial networks and operations)2 Worldwide on-line operator control and process monitoring of plants is possible using Internet technology according to another aspect of the present invention.

Solutions For Airports

The present invention also provides solutions for airports. In particular, individual installations and systems at an airport are maintained according to the present invention, particularly with the technical functioning of the airport installations. The present invention provides trouble-free operation of the installations, including maintenance and operating services and works within a fixed budget in providing these services. Agreed key performance indicators are used to insure efficiency of performance. According to the invention, the airport operator outsources operating services for electrical and mechanical engineering, building technology and infrastructure technology.

Professional services are provided under the present invention for new airport projects including planning and engineering, transportation and logistics, procurement of materials, installation and setup, commissioning, maintenance and operation of all airport sections. The professional services are also provided for airports in operation including maintenance and operation of outsource activities. For airports in operation or under construction, managed services are provided over the entire life cycle of the airports. Thus, comprehensive solutions are provided from a single source as a general contractor.

Cost effective maintenance of the airport is available by using international project experience and high technology skills in connection with best practice sharing to insure a minimum of maintenance costs and a higher productivity. Such maintenance solutions are tailored to the needs of the owner and the airport including providing maintenance services for seasonal and project related demand peaks and for ongoing care.

Under the present airport maintenance system, six process steps are applied to develop a maintenance improvement program. The first step is to develop a business plan. The aim of the business plan is to align the maintenance services to the business needs and to insure that these are directed to common goals. The business plan includes a vision statement, a mission statement, values, objectives and key performance indicators. Once achieved, the business plan is signed off at the executive level and is communicated to all employees. The plan is displayed around the site.

A second step is to develop maintenance policies in this step, basic rules are set to be followed in providing the maintenance services. These are jointly developed by production, engineering and maintenance personnel and reflect the policies of the company. The maintenance policies are signed off by the executives of the company as well.

In a third step, key performance indicators are identified. To measure the performance of the business and of the maintenance provider, the key result areas of the business must be identified and easily and regularly measured. The key performance indicators are built into a contract incentive system to align the goals of maintenance provider with the goals of the customer.

According to a fourth step, a maintenance improvement strategy is developed. The customer and the maintenance provider jointly determine the strategies required to improve the maintenance. These strategies must be detailed with the defined actions assigned to individuals. They are also to be regularly reviewed for progress and the need for change.

A fifth step of the process is that of benchmarking to measure the performance of the maintenance provider against others and against themselves. Benchmarking of key areas of the business is provided through simple key measures. Strategies are developed to improve against the benchmark and to include the maintenance improvement strategy.

In the sixth, and final, step an organization is provided to meet the customers requirements. The organization is reviewed in detail on an annual basis. The organization must support the contract functions while minimizing the contract overhead.

Another aspect of the present invention is to provide connecting service solutions. These operating services run without the customer lifting a finger. They cover energy supply plants, electrical installations, security and safety systems, information systems, public address and the guidance systems, telecommunications installations, baggage handling installations, runway lighting, air traffic control systems, and building maintenance systems as well as airplane maintenance hangers and terminal building technology.

The customer sees multiple paybacks from use of these airport services. Competitive advantages include: operating costs can be calculated to stay within fixed budgets, qualified specialists guarantee maximum operational safety, clear sole responsibility is provided for installed sections, increased human resource flexibility with no direct hire staff is provided, increased capital return with sell and lease modeling is provided as well, and the customer can concentrate on central airport processes without incurring training, tools or equipment costs.

Integral maintenance management supports the business goals of the customer, including minimizing maintenance costs, providing a long term high level of availability of high investment installations, minimizing break down risk to insure a high level of passenger satisfaction, providing a ready for action 24 hours a day 7 days a week maintenance system, reducing operating costs, and minimizing logistical needs.

In addition to the airport services, the present invention also provides integral plant maintenance, auxiliary process management, maintenance of electromechanical components and switch gears, maintenance and plant services for infrastructure installations, and professional maintenance support.

Services For Power Plants

The present invention likewise provides services targeted for power plants. Using the present invention, the business targets of the power plant maintenance are attained. In particular, the present business based maintenance provides that the customers' targets become the maintenance provider's targets, quality which meets the customers' requirements including price, performance and on-time service are provided. The maintenance further assists development of operational know-how, optimizes the processes to meet the companies goals, provides the company with the latest technology to optimize availability and logistics, and reduces overall costs and maintains constant quality standards.

The management system is provided for power plants as modular service packages.

In todays power plant market, crucial changes are currently taking place on a world wide basis. Deregulation of electrical power generation markets has placed supply networks at everyones disposal and has increased competitive pressures. A power plant operator is compelled to exploit every available opportunity to reduce operating expenses. In a deregulated market, only the best is good enough. Outsourced maintenance and operational services are provided to the highest standards, by specialists in engineering, technical support and business management fields. By outsourcing auxiliary processes, the power plant is enabled to optimize cost structure, which allows it to concentrate on management of core processes and valuable plant expertise while leaving the rest to qualified service providers. As a result, fixed costs are reduced.

By optimizing maintenance procedures and operational management, using dependable, professional and cost effective partnering, maintenance costs can be reduced by up to 50% for a power plant. The power plant may continually optimize the processes using business based maintenance management implementation of commercial targets according to the customers priorities. Thus, a reduction in costs of up to 50% may be available depending upon the condition of the plant.

The present invention provides maintenance services for power plants which meet entrepreneurial targets to provide optimized operational and maintenance costs. According to the present invention, servicing cycles and maintenance work are optimized according to the following principal: as much as necessary and as little as possible. This business based maintenance utilizes computer-aided diagnostics systems. The maintenance services function as an extension of the organization of the power plant to continuously improve profitability of the plant, involving the staff of the plant if the customer wishes. Long term partnership schemes are available to assist the customer in forecasting the budget.

Common objectives are provided under the present invention, including plant safety, improved return through reduction in maintenance of operating costs, extended plant life which insures a return of investment and longer payoffs, a lasting high level of plant availability, a reduction of planned and unplanned down time, preventative maintenance which is based on the plants' condition, performance enhancement, ongoing staff training, retrofitting work, emissions reduction, and minimized additional investment.

The present invention sets new standards of entrepreneurial targets for the power plant and on the basis of this information, full recommendations are made of appropriate maintenance and business strategy. State of the art methods and tools are used for organizing the maintenance processes and the staff organization which is required to implement them. Key parameters which reflect savings can he evaluated, including installed capacity per employee, annual energy output per employee, cost of operation of maintenance per Megawatt-hour generated, and plant availability.

The present invention provides operational optimization through outsourcing. Outsourcing is viewed as a holistic optimization technique which is used to increase the competitiveness of innovative industries. A fundamental principal is to have an external source that is responsible for all non-core business and which frees the customer to concentrate on the more important core processes. Under the present invention, selective outsourcing is used to fulfill the economic objectives of the power plant. A top priority to a power plant operator is to run the power plant in the most economically effective way. With economic targets in mind, concrete tasks must be defined and implemented as well as monitoring of the success of these tasks. Using a concept of the present invention, the responsibility for a variety of tasks in the power plant which are outside the field of expertise of the power plant operator are taken over by the maintenance provider. The range of services extends from management of peripheral plant maintenance right through to full plant operation covering all electrical, mechanical and business components, regardless of the manufacturer. In every situation, outsourcing is specifically mapped and designed to guarantee success and profitability.

Under the present invention, leasing schemes may be provided for auxiliary processes to enable optimization of asset management This approach allows more flexibility when making decisions about strategic plans for the future.

A determination is made as to how much outsourcing is profitable for the power plant. The hands on experience at every plant enables the customer to rely on a single provider of services including expert advice on all servicing needs. Engineers of the provider apply skill and expertise when involved in other manufacturer's plants.

A partnership is effectively formed between the provider and the power plant which is designed to follow and assist the business goals. A decision is made as to how much maintenance work should be performed in-house verses balancing with the outside services.

This enables the plant operator to focus the intention on the actual production related processes which improve the cost structures and increase the flexibility of the resource planning of the plant. The entire operation of the power plant can be entrusted to the outside provider.

A menu from which to choose either total or partial outsourcing of the power plant. First, a section entitled maintenance and management is provided which is broken down to devices and components, systems, and subsidiary plants. The devices may include motors or transducers or the like, the systems may include a demineralizer, air conditioning and ventilating systems or the like, and the subsidiary plants may include boilers, turbines or the like. Another option provided the customer is complete plant outsourcing.

In a second section of the menu, the operation and management of the plant is divided into systems and subsidiary plants. Under systems, such things as object safety and cleaning may be selected. Under subsidiary plants, secondary plants and the steam/water cycle may be selected. These menus are associated with a customers targets, including life cycle costs, target costs, plant availability, operational safety, and the like. Under modes of operation, operational links, maintenance windows, redundancies and the like may be provided. A further menu selection provides for selection equipment and type of devices including spare parts classification, storage, equipment access and the like. A maintenance strategy is provided which includes a plan of maintenance strategy, spare parts and logistics, a maintenance schedule, CMMS, an emergency, staff recruitment and the like.

The present invention also provides maintenance time schedules using known time scheduling software. Maintenance procedures follow on this including the generation of an estimated work schedule and then, using the maintenance time schedule, work orders, spare parts, tools, and safety measures are addressed. Documentation is also provided of the maintenance procedures.

A maintenance management system is included which looks at faults and breakdowns, plant data, generic data, analysis statistics, costs and the like.

The range of services for power plant maintenance and operational acceptance of the plant are that the disposal of the customer, insuring a quality and efficiency of the plant.

An objective of the present invention is that the power plant functions properly from its first day. Maintenance services should be prepared before the plant commences operation. This includes establishing the necessary inspection schedules, quality manuals and procedural instructions, introducing a maintenance management system adapted to the operational requirements, setting up a uniform documentation structure and including the spare parts as part of the management strategy.

During the operational phase of a power plant, the service packages of the integral power plant maintenance program are applied. Consulting services include targets, analysis of status quo, concept consulting including technical, commercial, and maintenance partnership schemes along with leasing schemes, business strategy, definition of job specifications, agreement on implementation, recruitment of personnel, staff transfers, and controlling.

Another aspect of the operational phase is maintenance, which includes inspection, servicing, repair, and application of the latest maintenance techniques. The inspection component provides for determination and assessment of actual conditions of the plant by means of the latest measuring techniques, even during the plants operation. The servicing component provides for maintaining the operational efficiency of the plant by regular preventative measures in order to preserve the target condition of the plant. The repair aspect provides that action is taken to restore the target condition and thus achieve a specified performance of the plant the latest maintenance techniques include condition oriented maintenance using analytical systems such as thermography, vibration measurement, and machine diagnostics. Innovative operational control and management systems are used.

A trouble shooting component includes analysis via a hot line or by teleservicing, remedial action via a hot line, teleservicing or on the spot action, and suggestions for optimization which are utilized for set up of appropriate preventative measures.

A technical backup is provided under the operational phase maintenance with workshops services, spare parts, tools and instruments services, 24 hour control center, and teleservicing. The workshop services provide repair., construction and calibration of components. The spare parts are provided including advising as to spare parts, ordering of the parts, storing and transportation of the spare parts along with all documentation therefor. Appropriate tools and measuring equipment are supplied and advise thereon is given. In the control center, the answers for reporting inquiries around the clock and return calls by qualified engineers are provided within a time limit which is stipulated. For teleservicing, on-line connections are made between the systems specialists and the process control system to enable rapid fault diagnosis and direct access to the system.

The operational management of the power plaint is also provided including organization, planning and execution for those customers which select operation of systems, subsidiary plants and complete operational management of the plant. The invention provides for installation and operation of workshops, storage centers, buildings, and infrastructure which adhere to the guaranteed performance targets.

These provide guarantees of availability, development of partnerships schemes which suit the individual customer requirements, and consulting of the business review processes.

The operational phase also provides for training and instruction. A draft concept is prepared with advise on training measures. Project qualification is included including a comprehensive process control and electro-technology utilization. Qualification of personnel including the maintenance manager, service manager and shift supervisors are included. In maintenance workshops, methods working conditions and work safety are reviewed.

Such management of auxiliary processes provides a new concept of work sharing. The customer concentrates on the core processes and entrusts the supporting peripheral auxiliary processes entirely to the maintenance services provider. At the customer request, the provider takes over selected partial service packages with both technical and commercial responsibility.

Another aspect of the present invention provides for modernization, or retrofitting and reconstruction of the power plant. Such retrofitting or reconstruction is based on customer targets, assessment of asset conditions, studies, and solution concepts. A plan of action is prepared including evaluating solutions, classification of interfaces, and viability of the plan. The project implementation is carried out from a single source. The provider offers planning, control, reporting services with coordination of the process sequences between the status quo and the new projects.

Another aspect of the power plant management method includes dismantling and recycling of the power plant. At the end of the commercial service life of a power plant; the dismantling of the power plant requires qualified management and specialized know-how in dismantling techniques and environmental protection. The maintenance provider may have experience in nuclear installations and guarantees that the dismantling tasks are economically undertaken in full compliance with applicable standards and regulations. An aspect of the dismantling process offered according to the present invention is decommissioning, conservation, planning the dismantling and disposal, actual dismantling, local removal of plants or equipment, and disposal in compliance with appertaining regulations. The present power plant management systems are applicable to fossil fuel power generation, nuclear power plants, and hydroelectric power plants: Maintenance strategies are developed for each, maintenance management is provided along with responsibility for spare parts, logistics, appointment of maintenance staff and operation of the plant with scheduled availability. Integrated sensors are used in power generators to collect measurements continuously during operation so that preventative maintenance actions can be taken when necessary. Continuous monitoring of the conditions on-line or telemonitoring allows the plant to operate at maximum efficiency. Utilizing the power plant management systems of the present invention, maintenance costs go down over time.

C-Business

A further aspect of the present invention is to provide services via electronic transaction and/or via the Internet, such as the World Wide Web.

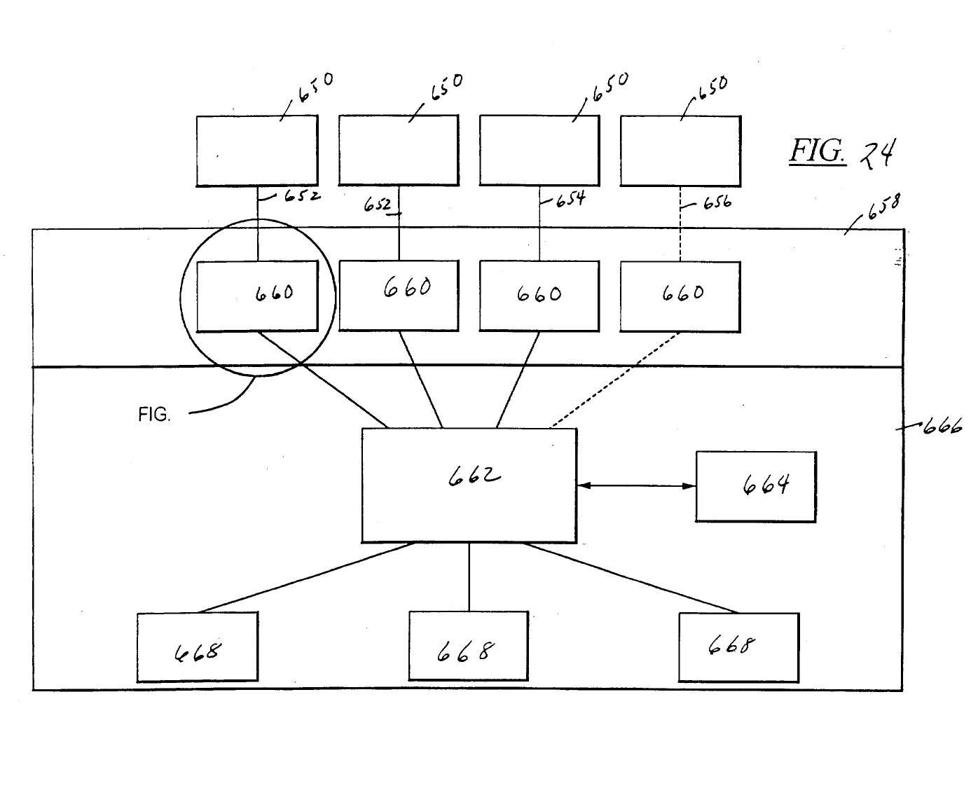

In FIG. 23, motors 600 are provided with sensors 602 that sense vibration, for example. The motors 600 and sensors 602 are connected to a database 604 withing which production data and condition data of the motors 600 is stored. A computer 606 is connected to access the database 604. The database 604 provides the motor condition data to a data bank of intelligent algorithms 608 which facilitate automatic control and sensing of the motor conditions. The database 604 is also accessed by a computerized maintenance management system 610. The system 610 is accessed by a person 612 either directly or through a personal data assistant 614. For instance, working orders may be provided for order processing. The person 612 and the system 610 further feed information to a further process 616.

This provides automatic solutions in a production planning system by automatically sensing equipment condition data via a network connection for use in the computerized maintenance management system, such as through the use of programmed intelligent algorithms. The motors 600 are shown only for an example. Generators may also be sensed The present invention is applicable to a wide variety of equipment in plants.

The condition sensing determines the condition as, “new”, “worn out”, “nearly new”, etc. This data may be sent over the Internet for processing according to the present invention.

By sensing this condition data, plant production may be better planned in advance. Availability of the plant for a project may be determined as a probability of breakdown. This information is derived from the analysis by the intelligent algorithms that are generated from the gathered experience under the present invention.

The person in the plant is able to input his or her impressions of the condition into the system components as well. The person is therefore integrated into the present system.

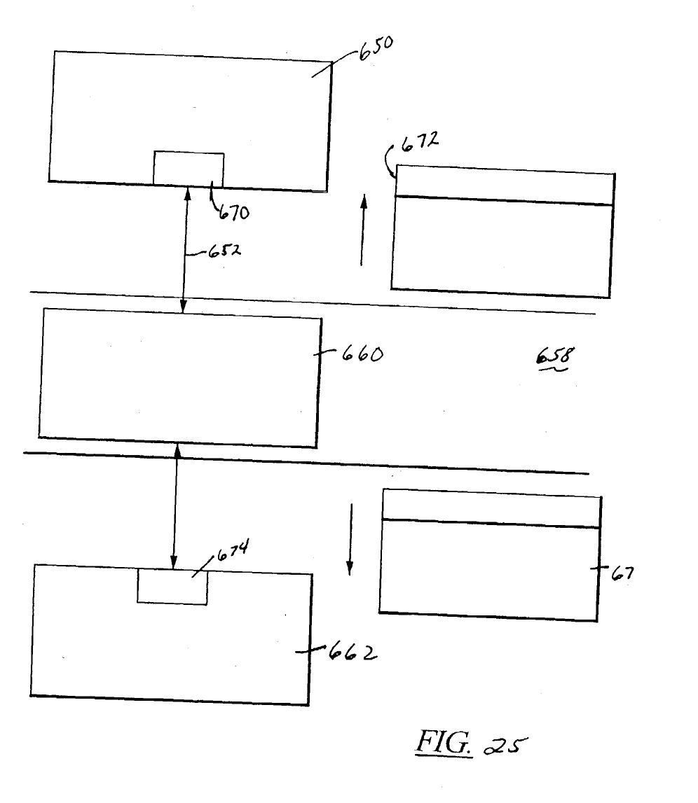

The information and software under the present invention are transferred electronically as shown in FIGS. 24 and 25. External maintenance providers and companies 650 communicate by network connections 652, wirelessly 654 or by telephone line 656, through a firewall 658 at ports 660 to a computerized maintenance management system 662. A production planning system 664 communicated with the computerized maintenance management system 662. These are within the information infrastructure 666 of the company or site of the maintenance service provider. Internal services and software works 668 for maintenance are available within the company infrastructure 666.

In further detail, FIG. 25 shows the external service provider 650 for maintenance services with an encryption/decryption component 670 at the network connection 652. Information 672 provided to the external provider include criticality and priority data, order data relating to organizational, technical and financial order, access information, and site specific information.

The port 660 in the firewall requires proof of authority, access restrictions and virus protection for data transferred therethrough.

In the computerized maintenance management system 662 is also provided an encryption/decryption 674. The information 676 transfer to the system 662 includes job finish information, accounting information, equipment status information, delay information, time information, status and forecasting information, etc.

The present invention provides that all communications data and software used in the present invention may be made available via the Internet, such as via the World Wide Web. The menus of modules available are provided to the customers via the Internet and software which implements the modules may either be downloaded via the Internet or may be run on a server connected to the customer via the Internet or other network.

Thus, there is shown and described a method for offering customized services to a plant, which offer a unique solution to each plant. Each customer potentially receives a different combination of service modules. A higher benefit is provided to the customer.

Industrial Applicability

The present invention finds industrial applicability in providing technical services and motor maintenance services to industrial plants, for instance.

Although other modifications and changes may be suggested by those skilled in the art, it is the intention of the inventors to embody within the patent warranted hereon all changes and modifications as reasonably and properly come within the scope of their contribution to the art.

We claim:

1. Customer-related technical services for obtaining an optimal financial result of a production plant by continuously applying the steps of:
a) providing a process description;
b) utilizing connected software tools and hardware tools; and
c) consulting an empirical database of experience.

2. Customer-related technical services as claimed in claim 1, wherein the step of providing a process description is performed worldwide according to the same criteria.

3. Customer-related technical services as claimed in claim l, further comprising the steps of:
utilizing homogenous forms of marketing/acquisition, standard basic contract forms, standard offer management, mobilization, operation and demobilization.

4. Customer-related technical services as claimed in claim l, further comprising the step of:
performing the processes in a standardized fashion according to defaults of a manual.

5. Customer-related technical services as claimed in claim l, further comprising the steps of:
utilizing a same course of action worldwide;
providing best practice sharing with respect to internationally comparable standards; and
introducing continuous improvement processes on a basis that is always the same.

6. Customer-related technical services as claimed in claim 1, further comprising the step of:
describing internal and external processes in a manual, the internal processes run on a customer plant.

7. Customer-related technical services as claimed in claim 6, wherein the manual is in writing in at least one of text form and diagram form.

8. Customer-related technical services as claimed in claim 6, wherein the manual is in a form readable by a personal computer and which can be printed.

9. Customer-related technical services as claimed in claim 8, wherein the manual is on a CD-ROM.

10. Customer-related technical services as claimed in claim 6, wherein the manual is on the World Wide Web.

11. Customer-related technical services as claimed in claim 10, wherein the manual is in an encoded form that can only be retrieved by a password.

12. Customer-related technical services as claimed in claim 6, wherein the manual is embedded into a virtual scene and includes simulation possibilities.

13. Customer-related technical services as claimed in claim 6, wherein the manual has a portal with selection possibilities for different technical services in its form that can executed on the PC.

14. Customer-related technical services claimed in claim 6, further comprising the step of:
subjecting content of the manual to a dynamic process which derives from an integration of a dynamically growing experience database into the manual.

15. Customer-related technical services claimed in claim 6, wherein the manual takes product-specific bits of information and plant-specific bits of information from experience databases from worldwide plants having a same production target and the same production methods.

16. Customer-related technical services as claimed in claim 1, wherein technical developments as well as methodical developments are a part of the experience database.

17. Customer-related technical services as claimed in claim 6, wherein the manual contains a work flow for maintenance teams.

18. Customer-related technical services as claimed in claim 11 wherein the manual suggests method groups and methods as work instructions dependent on the work flow.

19. Customer-related technical services as claimed in claim 6, wherein the manual organizes a consideration and the following implementation of the workers utilizing centers of excellence, said centers of excellence having special knowledge.

20. Customer-related technical services as claimed in claim 19, wherein the maintenance work is carried out by local units supported by the centers of excellence.

21. Customer-related technical services as claimed in claim 19, wherein the centers of excellence are distributed and networked such that it is always possible to access resources.

22. Customer-related technical services as claimed in claim 21, wherein the resources are experts.

23. Customer-related technical services as claimed in claim 22, wherein the experts can be reached 24 hours a day.

24. Customer-related technical services as claimed in claim 1, wherein said software tools are available via the World Wide Web.

25. Customer-related technical services, further comprising the steps of:
providing a system for implementing services with individual components which are obtainable on the market, said individual components being connected to a web-based knowledge-based database that continuously works with experience values.

26. Customer-related technical services as claimed in claim 25, wherein the individual components are software tools.

27. Customer-related technical services as claimed in claim 1, further comprising the step of:
utilizing external data and external tools for supplementing.

28. Customer-related technical services as claimed in claim 19, further comprising the step of:
transmitting data in an encoded fashion between the centers of excellence and the local units.

29. Customer-related technical services as claimed in claim 1, further comprising the step of:
improving standard software utilizing originally present experience data and improved experience data, said standard software being supplemented by experiences present in the database, utilizing worldwide knowledge therefor.

30. Customer-related technical services as claimed in claim 1, further comprising the step of:
monitoring a condition of the plant utilizing remote expert centers.

31. Customer-related technical services as claimed in claim 1, further comprising-the step of:
providing an application service host that is one of centrally arranged and arranged remotely connected by the Internet, distribution and data forwarding ensues worldwide.

32. Customer-related technical services as claimed in claim 31, wherein the application service host is isolated from the individual customer programs and has fire walls between the customers, so that the customer data cannot be viewed externally.

33. Customer-related technical services as claimed in claim 1, further comprising the step of:
collecting data from all customers and OEM's in an anonymous fashion using a central database.

34. Customer-related technical services as claimed in claim 33, further comprising the step of:
providing non-confidential portions of said data collected from the customers available via the World Web.

35. Customer-related technical services as claimed in claim 33, wherein the central database is on distributed servers.

36. Customer-related technical services as claimed in claim 1, further comprising the step of:
selecting databases by a portal.

37. Customer-related technical services as claimed in claim 36, wherein the step of selecting is by menu prompting.

38. Customer-related technical services as claimed in claim 33, wherein the experience database represents reference data from a provider's projects and customer projects, OEM data, industrial standard data, project experience data from other projects, standard maintenance, and standard operating plans.

39. Customer-related technical services as claimed in claim 1, further comprising the step of:
modifying OEM defaults and utilizing modified defaults when the OEM defaults arc not advantageous for the customer.

40. Customer-related technical services as claimed in claim 39, wherein said modified defaults are maintenance intervals.

41. Customer-related technical services as claimed in claim 1, further comprising the step of:
internationally acquiring experience data; organizing said experience data in a business-specific and system-specific manner; and
using key performance data and key performance indicators.

42. Customer-related technical services as claimed in claim 1, further comprising the step of:
providing feedback loops for performing the services with a start at the original plant condition data.

43. Customer-related technical services as claimed in claim 42, wherein plant start data serves to introduce initial measures.

44. Customer-related technical services as claimed in claim 43, further comprising the step of:
learning within a framework of measures how the plant reacts to the initial measures;
and deriving further measures for improvement from the learning step.

45. Customer-related technical services as claimed in claim 43, further comprising the step of:
entering an effect of measures into the experience database, as well as key performance data.

46. Customer-related technical services as claimed in claim 43, further comprising the step of:
introducing a request for changing the procedure which is business-specific into the manual.

47. Customer-related technical services as claimed in claim 43, further comprising the step of:
introducing modified methods and tools into the manual due to the necessary changes in the procedure.

48. Customer-related technical services as claimed in claim 1, further comprising the step of:
improving services by
a) a database,
b) a manual,
c) local project experiences, which are directly realized, and
d) an improvement of the software tools and hardware tools.

49. Customer-related technical services as claimed in claim 48, wherein said software tools are provided by access through the World Wide Web.

50. Customer-related technical services as claimed in claim 1, further comprising the step of:
providing that tools for improvement permanently communicate with the database.

51. A method of providing maintenance services at a plant, comprising the steps of:
providing a manual of operating principles common to all plants; and
providing farther information of operating principles common to all plants of a type of plant.

52. A method as claimed in claim 51, wherein said further information is provided through a network of computers.

53. A method of providing maintenance services at a plant, comprising the step of:
providing processes for addressing maintenance issues at the plant for each of a plurality of stages in a life of said plant.

54. A method as claimed in claim 53, wherein said stages include mobilization, operation and demobilization.

55. A method as claimed in claim 53, wherein said process includes providing tools for predetermined tasks, said tools being defined generically and being selected locally to said plant.

56. A method as claimed in claim 53, wherein said processes for addressing maintenance issues are driven by bottom line considerations for said plant.

57. A method for providing maintenance services at a plant, comprising the step of:
providing a knowledge repository of information specific to plants of the type of said plant, and
utilizing said knowledge repository to provide maintenance services to said plant.

58. A method as claimed in claim 57, wherein said knowledge repository is made accessible via the World Wide Web.

59. A method as claimed in claim 57, wherein said knowledge repository includes a database of information and experts selectively in communication with said plant.

60. A method as claimed in claim 57, wherein said experts initiate communication to said plant.

61. A method as claimed in claim 57, further comprising the step of:
providing teleservices for technical assistance in maintenance of said plant.

62. A method as claimed in claim 61, wherein said teleservices includes providing a heads-up display and person mounted camera for remote examination of said plant by said experts.

63. A method as claimed in claim 62, wherein said heads-up display includes overlays for identification of parts of said plant.

64. A method for implementation of customer-related maintenance services for an industrial system, comprising the steps of:
providing technical and maintenance services on a pro-active basis; and
providing modules of said technical and maintenance services wherein said modules are standardized and freely combinable with one another.

65. A method as claimed in claim 64, wherein said modules are selectable via the Internet.

66. A method of providing technical services to a customer comprising the steps of:
providing a menu of technical services offered to the customer, said technical services being modular; and
performing ones of said modular technical services which are selected by the customer as outsourced services, said services being customized according to the customer's needs.

67. A method as claimed in claim 66, wherein said menu is viewable via the World Wide Web and services listed therein are selectable via the Internet.

68. A method of providing technical services to a customer, comprising the steps of:
performing an evaluation of a customer's technical practices and facilities;
providing a menu of available technical services to the customer, said menu including modular technical services available on an outsourced basis;
making recommendations to the customer of selected ones of said modular technical services based on results of said evaluation; and
providing on an outsourced basis ones of said modular services selected by the customer.

69. A method as claimed in claim 68, wherein said menu and recommendations are communicated to the customer via the World Wide Web.

70. A method as claimed in claim 68, wherein ones of said modular services are provided via the Internet.

71. A method as claimed in claim 68, further comprising the steps of:
valuing compensation of said outsourced modular services depending on performance indicators.

72. A method as claimed in claim 68, further comprising the step of:
providing said technical and maintenance services in three performance levels.

73. A method as claimed in claim 68, further comprising the step of:
providing said technical and maintenance services at a business-oriented level as well as in a technology-oriented level and in an equipment level.

74. A method as claimed in claim 68, further comprising the step of:
universally performing the technical and maintenance services from managing, planning and coordinating the services down to operational activities with the processes implemented across all functions.

75. A method as claimed in claim 68, further comprising the step of:
providing condition monitoring and routine operational checks.

76. A method as claimed in claim 68, further comprising the step of:
providing an inventory optimization and reduction with a goal of reducing spare parts warehousing.

77. A method as claimed in claim 68, further comprising the step of:
providing a shared inventory with a goal of reducing inventory investment and carrying cost as well as storage, maintenance, and occupancy cost.

78. A method as claimed in claim 68, wherein said services are aimed to maintain equipment manufactured by the service provider as well as OEM equipment.

79. A method as claimed in claim 68, wherein said services include an equipment upgrade.

80. A method as claimed in claim 68, wherein said services include evaluating equipment for upgrade possibilities in order to improve their functionality.

81. A method as claimed in claim 68, wherein said services include verifying the equipment reliability.

82. A method as claimed in claim 68, wherein said services include providing maintenance services aligned to the customer's changing business objectives.

83. A method as claimed in claim 68, further comprising the steps of:
performing a maintenance business review.

84. A method as claimed in claim 83, wherein said maintenance business review routine includes: a standardized and repeatable assessment systematic on the basis of an assessment handbook.

85. A method as claimed in claim 68, further comprising the steps of:
performing an equipment condition assessment according to the methods of visual inspection, offline tests and online tests.

86. A method as claimed in claim 68, further comprising the steps of:
a comparative audit including a snapshot audit at two comparative points in time, wherein the data from each snapshot audit is utilized to evaluate individual equipment categories on a predetermined 1-10 scale.

87. A method as claimed in claim 68, wherein each equipment category is weighted according to its criticality, the weighted-score can be summarized to provide an overall equipment condition evaluation, which can be compared to other points in time.

88. A method as claimed in claim 68, further comprising the steps of:
providing said services on performance-oriented contract basis.

89. A method as claimed in claim 68, further comprising the steps of:
providing technical support programs including services for electrical distribution systems, automation and drives systems, and rotating equipment.

90. A method as claimed in claim 68, wherein said steps are implemented according to the prescriptions of a service manual.

91. A method as claimed in claim 68, wherein said industrial system is one of a airport, steel mill hospital, mines, ship yard, large building, hotel, chemical plant, cement plant, subway system, railway system, container terminal, oil drilling rig or platform, paper mill, oil or natural gas pipeline system, lime plant, water treatment plant including desalination, fresh water pipelining and waste water treatment, and food service facilities.

92. A method for implementation of customer-related maintenance services for an industrial motor system, comprising the steps of:
providing motor maintenance services on a pro-active basis; and
providing modules of said motor maintenance services wherein said modules are standardized and freely combinable with one another.

93. A method of providing motor services to a customer, comprising the steps of:
providing a menu of motor services offered to the customer, said motor services being modular;
performing ones of said modular motor services which are selected by the customer as outsourced services, said services being customized according to the customer's needs.

94. A method of providing motor services to a customer, comprising the steps of:
performing an evaluation of a customer's technical practices and facilities regarding the motor management;
providing a menu of available motor services to the customer, said menu including modular motor services available on an outsourced basis;
making recommendations to the customer of selected ones of said modular motor services based on results of said evaluation; and
providing on an outsourced basis ones of said modular services selected by the customer.

95. A method as claimed in claim 94, further comprising the steps of:
changing compensation of said outsourced modular services depending on performance indicators.

96. A method as claimed in claim 94, further comprising the step of:
providing said technical and maintenance services in two performance levels.

97. A method as claimed in claim 96, further comprising the step of:
providing said technical and maintenance services at a business-oriented level as well as in a technology-oriented level.

98. A method as claimed in claim 94, further comprising the step of:
universally performing the motor maintenance services from managing, planning and coordinating the services down to operational activities with the processes implemented across all functions.

99. A method as claimed in claim 94, further comprising the step of:
providing condition monitoring derived from a business based maintenance analysis.

100. A method as claimed in claim 94, further comprising the step oft providing an inventory optimization and reduction with a goal of reducing spare motors warehousing.

101. A method as claimed in claim 94, further comprising the step of:
providing a shared inventory with a goal of reducing motor inventory investment and carrying cost as well as storage, maintenance, and occupancy cost.

102. A method as claimed in claim 94, wherein said services are aimed to maintain motors manufactured by the service provider as well as OEM motors.

103. A method as claimed in claim 94, wherein said services include an motor upgrade.

104. A method as claimed in claim 94, wherein said services include evaluating motors for upgrade possibilities in order to improve their functionality.

105. A method as claimed in claim 94, wherein said services include verifying the motor reliability.

106. A method as claimed in claim 94, wherein said services include providing maintenance services aligned to the customer's changing business objectives.

107. A method as claimed in claim 94, further comprising the steps of:
performing a motor management review.

108. A method as claimed in claim 107, wherein said motor management review routine includes: a standardized and repeatable assessment systematic on the basis of an assessment handbook.

109. A method as claimed in claim 94, further comprising the steps of:
performing an motor condition assessment according to the methods of visual inspection, offline tests and online tests.

110. A method as claimed in claim 94, further comprising the steps of:
a comparative audit including a snapshot audit at two comparative points in time, wherein the data from each snapshot audit is utilized to evaluate individual motor categories on a predetermined 1-10 scale.

111. A method as claimed in claim 94, wherein each motor category is weighted according to its criticality, the weighted-score can be summarized to provide an overall motor condition evaluation, which can be compared to other points in time.

112. A method as claimed in claim 94, further comprising the steps of:
providing said services on performance-oriented contract basis.

113. A method as claimed in claim 94, wherein said steps are implemented according to the prescriptions of a service manual.

114. A method as claimed in claim 94, wherein said industrial system is one of a airport, steel mill, hospital, mines, ship yard, large building, hotel, chemical plant, cement plant, subway system, railway system, container terminal, oil drilling rig or platform, paper mill, oil or natural gas pipeline system, lime plant, water treatment plant including desalination, fresh water pipelining and waste water treatment, and food service facilities.

115. A method of providing maintenance and maintenance management services, comprising the steps of:
storing non-confidential customer information in a database; and
making said non-confidential customer information available over a network.

116. A method as claimed in claim 115, wherein said network includes the World Wide Web.

117. A method as claimed in claim 115, wherein said database is on personal computers and are made available as modules on a menu.

118. A method as claimed in claim 115, wherein said information available over said network includes software modules and devices connected to said personal computers.

119. A method as claimed in claim 115, further comprising the steps of:
obtaining best practice software information from said database; and
providing best practice software via the Internet.

120. A method of providing maintenance and maintenance management services, comprising the steps of:
providing a menu of maintenance and maintenance management services accessible over the World Wide Web; and
performing maintenance and maintenance management services selected from said menu.

121. A method as claimed in claim 120, wherein one of said maintenance and maintenance management services includes providing access to a program to calculate costs of products and processes via the World Wide Web.

122. A method of providing services to plant, comprising the steps of:
providing a menu of available services to plants by an outside provider,
determining business impact of providing at least some of the services by said outside provider utilizing knowledge management, and
providing to said plant services selected from said menu by said outside provider utilizing knowledge management.

123. A method as claimed in claim 122, wherein said determining step includes determining a bottom impact on profitability of said plant.

124. A method as claimed in claim 122, wherein said menu of available services include:
planning of said plant, erecting of said plant, operating said plant, and managing shutdown of said plant.

125. A method as claimed in claim 122, wherein said service of planning of said plant includes searching for a site for said plant.

126. A method as claimed in claim 122, further comprising the step of:
providing a presentation of said menu of available services.

127. A method as claimed in claim 126, wherein said presentation includes a standardized procedure for doing business, said standardized procedure being presented graphically and in text.

128. A method as claimed in claim 122, wherein said services include technical services.

129. A method as claimed in claim 122, further comprising the step of:
providing an information model, said information model including integrated tools in communication with one another.

130. A method as claimed in claim 129, wherein said tools include local implementations of tools.

131. A method as claimed in claim 122, wherein each of said services is a modular standardized value added service.

132. A method as claimed in claim 122, wherein said step of determining includes the steps of:
interviewing personnel of said plant; and
recommending a selection of services selected from said menu for optimum operation of said plant based on forecasts of bottom line figures, said recommendation being specific to said plant.

133. A method as claimed in claim 122, wherein said services include:
purchase of energy, maintaining spare parts.
